(19) United States
(12) Patent Application Publication
(10) Pub. No.: US 2026/0170809 A1
(43) Pub. Date: Jun. 18, 2026

(54) SYSTEM AND METHOD FOR DATA DISTILLATION USING MACHINE LEARNING

(71) Applicant: ROYAL BANK OF CANADA, Toronto (CA)

(72) Inventors: Ahmad SAJEDI, Toronto (CA); Samir KHAKI, Toronto (CA); Ehsan AMJADIAN, Toronto (CA); Xiwu LIU, Toronto (CA); Yuri LAWRYSHYN, Toronto (CA); Konstantinos N. PLATANIOTIS, Toronto (CA)

(21) Appl. No.: 18/986,270

(22) Filed: Dec. 18, 2024

(51) Int. Cl. G06V 10/774; G06V 10/764; G06V 10/77; G06V 10/776; G06V 10/82

(52) U.S. Cl. CPC G06V 10/774; G06V 10/764; G06V 10/7715; G06V 10/776; G06V 10/82

(57) ABSTRACT

Systems and methods for efficient image data processing for machine learning are disclosed. An example system may include: a processor and a non-transitory memory storing instructions that when executed by the processor, causes the system to: store or access a machine learning generative model including a generator network; and for each iteration of a plurality of iterations: generate a synthetic image using the generator network based on a random image from a random image dataset; compute an embedding loss using an embedding matching module for said iteration based on the synthetic image and an original image; compute a prediction matching loss for said iteration using a prediction matching module based on the synthetic image and the original image; determine a training loss for said iteration using the embedding loss and the prediction matching loss; and update the generator network of the machine learning generative model based on the training loss.

### FIELD

Embodiments of the present disclosure relate to the field of image data processing and machine learning for computer vision, and more particularly, to the field of data distillation using machine learning with a generative model.

### BACKGROUND

Deep learning has been successful in various domains, including computer vision and natural language processing; however, it often relies on deep neural networks (DNNs) and large-scale datasets. These requirements necessitate significant investments in training time, data storage, and electricity consumption, making training impractical for those with limited computational resources. Techniques such as pruning, quantization, and model distillation show promise in reducing these computational expenses while preserving performance.

Model distillation is one example system that transfers the informative knowledge from a large teacher model to a smaller student one to facilitate model compression. Recently, dataset distillation has emerged as a promising data-efficient learning approach that distills knowledge from a large training dataset into a small set of synthetic images. These images enable models to attain test performance comparable to those trained on the original dataset. Dataset distillation is widely applied in computer vision for applications like neural architecture search, continual learning, federated learning, and privacy-preserving.

Dataset distillation is used to synthesize small-scale data from a large real dataset using meta-learning, minimizing training loss differences between the synthetic and original data. Meta-learning involves bi-level optimization and incurs significant computational costs. To mitigate this, researchers employed kernel methods to facilitate the inner optimization loop, as seen in Kernel Inducing Points or KIP (see Nguyen, T., et al.: Dataset Distillation with Infinitely Wide Convolutional Networks. Advances in Neural Information Processing Systems 34, 5186-5198, 2021), and FRePo (see Zhou, Y., et al.: Dataset Distillation Using Neural Feature Regression, Advances in Neural Information Processing Systems, 2022).

Other studies adopted surrogate objectives to tackle unrolled optimization problems in meta-learning. For example. DC (see Zhao, B., et al.: Dataset Condensation with Gradient Matching, Ninth International Conference on Learning Representations 2021) and DSA (see Zhao, B., et al.: Dataset Condensation with Differentiable Siamese Augmentatio, International Conference on Machine Learning. pp. 12674-12685. PMLR 2021) align gradients between synthetic and real datasets for distillation.

Meanwhile, DM (see Zhao, B., et al.: Dataset Condensation with Distribution Matching, Proceedings of the IEEE/CVF Winter Conference on Applications of Computer Vision. pp. 6514-6523, 2023), CAFE (see Wang, K., et al.: Cafe: Learning to Condense Dataset by Aligning Features, Proceedings of the IEEE/CVF Conference on Computer Vision and Pattern Recognition. pp. 12196-12205, 2022), and DAM (see Sajedi, A., et al.: DataDAM: Efficient Dataset Distillation with Attention Matching, Proceedings of the IEEE/CVF International Conference on Computer Vision. pp. 17097-17107, 2023) use distribution-matching to alleviate bias caused by original samples with large gradients.

Further, MTT (see Cazenavette, G., et al.: Dataset Distillation by Matching Training Trajectories, Proceedings of the IEEE/CVF Conference on Computer Vision and Pattern Recognition. pp. 4750-4759, 2022), FTD (see Du, J., et al.: Minimizing the Accumulated Trajectory Error to Improve Dataset Distillation, Proceedings of the IEEE/CVF Conference on Computer Vision and Pattern Recognition. pp. 3749-3758, 2023), and TESLA (see Cui, J., et al.: Scaling Up Dataset Distillation to Imagenet-1 k with Constant Memory. In: International Conference on Machine Learning. pp. 6565-6590. PMLR 2023) match model parameter trajectories to improve performance.

However, the above-mentioned data distillation methods distill information into pixels, leading to a linear growth in computational costs with class numbers and resolutions. This limits scalability with larger datasets and poses challenges for cross-architecture generalization and re-distillation efficiency.

In contrast, Data-to-Model Distillation (D2M) systems as disclosed herein are configured and implemented to distill knowledge into the generative model to address the limitations posed by pixel-wise dataset distillation.

Generative adversarial networks (GANs) (see Goodfellow, et al.: Generative Adversarial Nets, Advances in Neural Information Processing Systems 27, 2014) can generate realistic images that deceive human observers. A variety of GAN models, such as CycleGAN (see Zhu, J. Y., et al: Unpaired Image-To-Image Translation Using Cycle-Consistent Adversarial Networks, Proceedings of the IEEE international conference on computer vision. pp. 2223-2232, 2017), InfoGAN (see Chen, X., et al.: InfoGAN: Interpretable representation learning by information Maximizing Generative Adversarial Nets. Advances in Neural Information Processing Systems 29, 2016), and BigGAN (see Brock, A., et al.: Large Scale Gan Training for High Fidelity Natural Image Synthesis, International Conference on Learning Representations, 2018) have since emerged for tasks like image manipulation, super-resolution, and object detection.

However, the above-mentioned GAN-generated images often prioritize visual realism over informativeness, which may not be ideal for data-efficient classification tasks. Some methods have been proposed to address this by generating samples that can be used to train deep neural networks more efficiently.

GLAD system (see Cazenavette, G., et al.: Generalizing Dataset Distillation via Deep Generative Prior, Proceedings of the IEEE/CVF Conference on Computer Vision and Pattern Recognition. pp. 3739-3748, 2023) distills numerous images into a few intermediate feature vectors in the GAN's latent space to help cross-architecture generalization.

Another two-stage system, DiM (see Wang, K., et al.: DiM: Distilling Dataset into Generative Model. arXiv preprint arXiv:2303.04707, 2023) optimizes generative models to create training samples for 10-class classification tasks.

The above-mentioned distillation systems and methods face challenges such as high training costs, the necessity of retraining for different distillation ratios, and scalability constraints for complex, high-resolution datasets.

### SUMMARY

Embodiments based on a Data-to-Model Distillation (D2M) framework are described herein, which when executed, can generate a new, smaller dataset that distills an original dataset's knowledge into learnable parameters of a pre-trained generative model, by aligning rich representations extracted from real and generated images. The learned generative model can then produce informative training images for different distillation ratios and deep architectures.

As described herein, extensive experiments on a number of datasets of varying resolutions show that the embodiments in this disclosure demonstrate superior performance, re-distillation efficiency, and cross-architecture generalizability. The D2M system effectively scales up to high-resolution 128×128 ImageNet-1K. Furthermore, the D2M system offers practical benefits for downstream applications in neural architecture search.

In accordance with one aspect, there is provided a computer system for efficient image data processing for machine learning, the computer system comprising: a processor; and a non-transitory memory storing instructions that when executed by the processor, causes the system to: store or access a machine learning generative model comprising a generator network; store or obtain an original image dataset comprising a plurality of original images; store or obtain a random image dataset comprising a plurality of random noise images and corresponding labels; for each iteration from a plurality of iterations for refining the machine learning generative model: generate a synthetic image using the generator network, based on a respective random image and a corresponding label for said respective random image from the random image dataset; process the synthetic image using an embedding matching module to generate a synthetic embedding output for the generated synthetic image in a forward pass; process a respective original image from the original image dataset using said embedding matching module to generate an original embedding output for the respective original image in a forward pass; compute an embedding loss for said iteration based on the synthetic embedding output and the original embedding output; determine a training loss for said iteration using the embedding loss; and update the generator network of the machine learning generative model based on the training loss.

In some embodiments, when executed by the processor, the instructions cause the system to, for each said iteration from the plurality of iterations for refining the machine learning generative model: compute a prediction matching loss for said iteration using a prediction matching module based on the synthetic embedding output and the original embedding output; and determine the training loss for said iteration using the embedding loss and the prediction matching loss.

In some embodiments, the synthetic embedding output comprises a feature map for the respective synthetic image and the original embedding output comprises a feature map for the respective original image.

In some embodiments, the embedding loss is computed based on the feature map for the respective synthetic image and the feature map for the respective original image.

In some embodiments, the system comprises a randomly selected neural network implemented to align respective channel-wise attention maps between the original image dataset and a synthetic image dataset comprising the synthetic images generated by the generator network.

In some embodiments, the embedding matching module generates the embedding losses across different feature extraction layers using the neural network.

In some embodiments the neural network comprises a Convolutional Neural Network (ConvNet) architecture.

In some embodiments, the embedding matching module uses the most discriminative regions of the feature maps, based on the respective channel-wise attention maps, to align feature distributions between the original image dataset and the synthetic image dataset generated by the generator network.

In some embodiments, the synthetic embedding output comprises a predicted logit for the respective synthetic image and the original embedding output comprises a predicted logit for the respective original image.

In some embodiments, the prediction matching loss is computed based on the predicted logit for the respective synthetic image and the predicted logit for the respective original image.

In some embodiments, the system comprises a randomly selected neural network implemented to minimize differences in soft-label output predictions, by the generator network, between the output predictions based on the original image dataset and the output predictions based on the synthetic images generated by the generator network.

In some embodiments, when the prediction matching loss is determined, the training loss comprises an augmented Lagrangian of the embedding loss and the prediction matching loss.

In some embodiments, the set of instructions when executed by the processor, causes the system to: during each said iteration, randomly select a neural network randomly from a model data store comprising neural networks with different initializations.

In some embodiments, the set of instructions when executed by the processor, causes the system to: after completing the plurality of iterations for refining the machine learning generative model: obtain a first distillation ratio; generate a first set of training images using the trained generator network based on the original image dataset and the first distillation ratio; and store or process the first set of training images for downstream classification tasks.

In some embodiments, the set of instructions when executed by the processor, causes the system to: after the generation of the first set of training images: obtain a second distillation ratio different from the first distillation ratio; generate a second set of training images using the trained generator network, without retraining the generator network, based on the original image dataset and the second distillation ratio; and store or process the second set of training images for downstream classification tasks.

In another aspect, there is provided a computer-implemented method for training a machine learning model for image data distillation, the method includes: storing or accessing a machine learning generative model comprising a generator network; storing or obtaining an original image dataset comprising a plurality of original images; storing or obtaining a random image dataset comprising a plurality of random noise images and corresponding labels; for each iteration from a plurality of iterations for refining the machine learning generative model: generating a synthetic image using the generator network, based on a respective random image and a corresponding label for said respective random image from the random image dataset; processing the synthetic image using an embedding matching module to generate a synthetic embedding output for the generated synthetic image in a forward pass; processing a respective original image from the original image dataset using said embedding matching module to generate an original embedding output for the respective original image in a forward pass; computing an embedding loss for said iteration based on the synthetic embedding output and the original embedding output; determining a training loss for said iteration using the embedding loss; and updating the generator network of the machine learning generative model based on the training loss.

In some embodiments, the method may include, for each said interation: computing a prediction matching loss for said iteration using a prediction matching module based on the synthetic embedding output and the original embedding output; and determining the training loss for said iteration using the embedding loss and the prediction matching loss.

In some embodiments, the synthetic embedding output comprises a feature map for the respective synthetic image and the original embedding output comprises a feature map for the respective original image.

In some embodiments, the embedding loss is computed based on the feature map for the respective synthetic image and the feature map for the respective original image.

In some embodiments, the method includes randomly selecting and implemeting a neural network to align respective channel-wise attention maps between the original image dataset and a synthetic image dataset comprising the synthetic images generated by the generator network.

In some embodiments, the embedding matching module generates the embedding losses across different feature extraction layers using the neural network.

In some embodiments the neural network comprises a Convolutional Neural Network (ConvNet) architecture.

In some embodiments, the embedding matching module uses the most discriminative regions of the feature maps, based on the respective channel-wise attention maps, to align feature distributions between the original image dataset and the synthetic image dataset generated by the generator network.

In some embodiments, the synthetic embedding output comprises a predicted logit for the respective synthetic image and the original embedding output comprises a predicted logit for the respective original image.

In some embodiments, the prediction matching loss is computed based on the predicted logit for the respective synthetic image and the predicted logit for the respective original image.

In some embodiments, the method includes randomly selecting and implementing a neural network to minimize differences in soft-label output predictions, by the generator network, between the output predictions based on the original image dataset and the output predictions based on the synthetic images generated by the generator network.

In some embodiments, when the prediction matching loss is determined, the training loss comprises an augmented Lagrangian of the embedding loss and the prediction matching loss.

In some embodiments, during each said iteration, the method includes randomly selecting a neural network from a model data store comprising neural networks with different initializations for the embedding matching module.

In some embodiments, the method includes, after completing the plurality of iterations for refining the machine learning generative model: obtaining a first distillation ratio; generating a first set of training images using the trained generator network based on the original image dataset and the first distillation ratio; and storing or processing the first set of training images for downstream classification tasks.

In some embodiments, the method includes, after the generation of the first set of training images: obtaining a second distillation ratio different from the first distillation ratio; generating a second set of training images using the trained generator network, without retraining the generator network, based on the original image dataset and the second distillation ratio; and storing or processing the second set of training images for downstream classification tasks.

In yet another aspect, there is provided a non-transitory computer readable medium storing machine interpretable instructions, which when executed by a processor, cause the processor to perform: storing or accessing a machine learning generative model comprising a generator network; storing or obtaining an original image dataset comprising a plurality of original images; storing or obtaining a random image dataset comprising a plurality of random noise images and corresponding labels; for each iteration from a plurality of iterations for refining the machine learning generative model: generating a synthetic image using the generator network, based on a respective random image and a corresponding label for said respective random image from the random image dataset; processing the synthetic image using an embedding matching module to generate a synthetic embedding output for the generated synthetic image in a forward pass; processing a respective original image from the original image dataset using said embedding matching module to generate an original embedding output for the respective original image in a forward pass; computing an embedding loss for said iteration based on the synthetic embedding output and the original embedding output; determining a training loss for said iteration using the embedding loss; and updating the generator network of the machine learning generative model based on the training loss.

In some embodiments, the synthetic embedding output comprises a feature map for the respective synthetic image and the original embedding output comprises a feature map for the respective original image.

In some embodiments, the embedding loss is computed based on the feature map for the respective synthetic image and the feature map for the respective original image.

In some embodiments, a neural network is randomly selected and implemented to align respective channel-wise attention maps between the original image dataset and a synthetic image dataset comprising the synthetic images generated by the generator network.

In some embodiments, the embedding matching module generates the embedding losses across different feature extraction layers using the neural network.

In some embodiments, the embedding matching module uses the most discriminative regions of the feature maps, based on the respective channel-wise attention maps, to align feature distributions between the original image dataset and the synthetic image dataset generated by the generator network.

In some embodiments, the synthetic embedding output comprises a predicted logit for the respective synthetic image and the original embedding output comprises a predicted logit for the respective original image.

In some embodiments, the machine interpretable instructions, when executed by a processor, cause the processor to perform, for each said interation: computing a prediction matching loss for said iteration using a prediction matching module based on the synthetic embedding output and the original embedding output; and determining the training loss for said iteration using the embedding loss and the prediction matching loss.

In some embodiments, the prediction matching loss is computed based on the predicted logit for the respective synthetic image and the predicted logit for the respective original image.

In some embodiments, a randomly selected neural network is implemented to minimize differences in soft-label output predictions, by the generator network, between the output predictions based on the original image dataset and the output predictions based on the synthetic images generated by the generator network.

In some embodiments, when the prediction matching loss is determined, the training loss comprises an augmented Lagrangian of the embedding loss and the prediction matching loss.

In some embodiments, the machine interpretable instructions, when executed by the processor, cause the processor to perform: during each said iteration, randomly select a neural network from a model data store comprising neural networks with different initializations for the embedding matching module.

In some embodiments, the machine interpretable instructions, when executed by the processor, cause the processor to perform: after completing the plurality of iterations for refining the machine learning generative model: obtaining a first distillation ratio; generating a first set of training images using the trained generator network based on the original image dataset and the first distillation ratio; and storing or processing the first set of training images for downstream classification tasks.

In some embodiments, the machine interpretable instructions, when executed by the processor, cause the processor to perform: after the generation of the first set of training images: obtaining a second distillation ratio different from the first distillation ratio; generating a second set of training images using the trained generator network, without retraining the generator network, based on the original image dataset and the second distillation ratio; and storing or processing the second set of training images for downstream classification tasks.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

In the Figures, embodiments are illustrated by way of example. It is to be expressly understood that the description and figures are only for the purpose of illustration and as an aid to understanding.

Embodiments will now be described, by way of example only, with reference to the below figures:

FIG. 1 illustrates three different data distillation frameworks in concept;

FIG. 2 illustrates a simplified D2M framework including a machine learning generative model for efficient data processing, in accordance with some embodiments;

FIG. 3 is a schematic block diagram of an example computer system for implementing said D2M framework, in accordance with some embodiments;

FIG. 4 illustrates an example set of pseudo code for an example training process performed by a D2M system, in accordance with some embodiments;

FIGS. 5A, 5B and 5C each shows a table illustrating a performance comparison between an example embodiment of D2M system and other data distillation systems, in accordance with some embodiments;

FIG. 6A illustrates a table with example hyperparameters for example embodiments of D2M system, in accordance with some embodiments;

FIG. 6B shows GPU hours for re-distillation process from IPC1 to IPC10 and IPC50 on CIFAR-10, in accordance with some embodiments;

FIG. 6C shows cross-architecture performance on CIFAR-10 with 50 images per class, in accordance with some embodiments;

FIG. 7 shows two charts illustrating accuracy and count of parameters on 128×128 ImageNet-1K dataset, in accordance with some embodiments;

FIG. 8 shows three charts illustrating accuracy rate performed by D2M system with different parameters, in accordance with some embodiments;

FIG. 9 is a schematic diagram of an example computing device that implements a D2M system, in accordance with some embodiments;

FIG. 10 shows an example process performed by a D2M system in FIG. 3 for training or refining a machine learning model for image data distillation, in accordance with some embodiments;

FIG. 11A shows two tables listing performance comparison for various data distillation models and D2M system employing various generative models, in accordance with some embodiments;

FIG. 11B shows a table for neural network search on images generated by various data distillation systems, in accordance with some embodiments;

FIG. 11C provides an overview of various datasets used in some of the experiments conducted using example embodiments of D2M system and other distillation systems, in accordance with some embodiments;

FIG. 11D shows a comprehensive list of the ImageNet classes within each subset, in accordance with some embodiments;

FIGS. 12A to 12D shows example groups of synthetic images generated by an example embodiment of D2M system, in accordance with some embodiments;

FIG. 13 illustrates GPU hours spent on distillation for FTD and D2M on CIFAR-10 with different IPCs, in accordance with some embodiments;

FIG. 14 shows the number of learnable parameters on 32×32 resolution CIFAR-100 with different IPCs for small IPCs, in accordance with some embodiments;

FIGS. 15A and 15B shows GPU distillation time and number of learnable parameters used by example embodiments of D2M systems with implemented each with a different generative model, in accordance with some embodiments;

FIGS. 16 to 21 show rank correlation of performance between the proxy dataset, derived from Random, DSA, DM, CAFE, DataDAM (see Sajedi, A., et al.: DataDAM: Efficient Dataset Distillation with Attention Matching, Proceedings of the IEEE/CVF International Conference on Computer Vision. pp. 17097-17107, 2023), and D2M system, in accordance with some embodiments;

FIGS. 22 to 24 illustrate distributions of the synthetic images learned by various data distillation methods on the CIFAR-10 dataset with IPC 50, in accordance with some embodiments;

FIG. 25 shows a table comparing data distillation performance of an example embodiment of D2M system and Random system for IPC 1 and 10 at a resolution of 128 pixels, in accordance with some embodiments; and

FIGS. 26 to 35 each illustrates a pair of images for a respective class of images generated by an example embodiment of D2M system at 256×256 resolution, in accordance with some embodiments.

### DETAILED DESCRIPTION

In recent years, the development of more powerful machine learning has been increasingly dependent on large-scale training datasets, which presents a challenge on the computing resources, including for example, processing power, memory storage, time, and infrastructure, required for storing the datasets or for training the machine learning models using said datasets.

Dataset distillation aims to distill the knowledge of a large-scale real dataset into small yet informative synthetic data such that a model trained on it performs as well as a model trained on the full dataset. Despite recent progress, existing dataset distillation methods often struggle with computational efficiency, scalability to complex high-resolution datasets, and generalizability to deep architectures. These approaches typically require retraining when the distillation ratio changes, as knowledge is embedded in raw image pixels.

Traditional data-centric methods, known as coreset selection, reduce training costs by selecting a subset of the original dataset based on specific metrics. However, these approaches have a deficiency in representation capability and coverage of chosen samples, leading to suboptimal results for classification tasks. Existing dataset distillation algorithms overcome these limitations by synthesizing a small yet informative dataset that aligns characteristics between synthetic and real images. Drawing on seminal work, researchers have developed various methods, including gradient matching, distribution matching, trajectory matching, and kernel-inducing points. These works initialize a small number of learnable images and update their raw pixel values using different matching strategies during distillation.

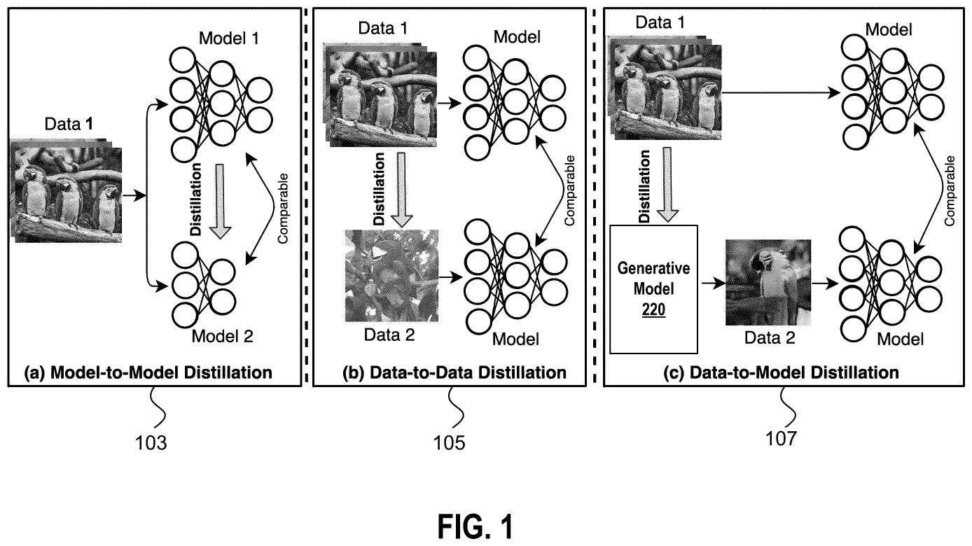

FIG. 1 illustrates, in the first two distillation frameworks: (a) model-to-model distillation 103; and (b) data-to-data distillation 105. Existing dataset distillation suffer from three major drawbacks. First, they require complete retraining of distillation algorithms when the distillation ratio or the number of images per class (IPC) changes, which leads to a computationally demanding re-distillation process. Second, these methods generally struggle with high-resolution, large-scale datasets (e.g., 128×128 ImageNet-1K, Deng, J., et al.: Imagenet: A Large-Scale Hierarchical Image Database, 2009 IEEE Conference On Computer Vision and Pattern Recognition. pp. 248-255) and tend to distill visually noisy images. Lastly, the distilled dataset often performs poorly on architectures like ResNet (see He, K., et al.: Deep Residual Learning for Image Recognition, Proceedings of the IEEE Conference On Computer Vision and Pattern Recognition. pp. 770-778, 2016), DenseNet (Huang, G., et al.: Densely connected convolutional networks, Proceedings of the IEEE Conference On Computer Vision and Pattern Recognition, pp. 4700-4708, 2017) and ViT (Dosovitskiy, A., et al.: An Image is Worth 16×16 Words: Transformers for Image Recognition at Scale. arXiv preprint arXiv:2010.11929, 2020). These issues partially stem from parameterizing the synthetic dataset in pixel space.

Optimizing raw pixels can capture high-frequency, detailed information that is not essential for downstream tasks and is susceptible to over-fitting during training architecture. Moreover, employing pixel-level optimization on high-resolution, large-scale data incurs significant computational and memory costs, rendering it unscalable for such datasets.

In this disclosure, a novel data distillation framework, referred to as Data-to-Model distillation (D2M), is described. FIG. 1 shows a simplified concept of the D2M system in (c) data-to-model distillation 107 based on a generative model 220.

In one example embodiment, a D2M system includes a Data-to-Model (D2M) distillation engine that syntenizes and transfers information from an original dataset (e.g., an original image dataset) into a generative model, through a training process of said generative model, rather than transferring information based on raw pixel data. The disclosed D2M system effectively addresses the aforementioned issues in existing data distillation methods by parameterizing a synthetic image dataset produced by a machine learning generative model (or simply “generative model”) within the parameter space of the generative model, which can include, for example, a Generative Adversarial Network (GAN) having a generator network.

Recent generative-based dataset distillation methods typically distill large-scale datasets into the latent space of a specific GAN model. For example, GLAD utilizes various intermediate feature spaces of StyleGAN-XL to characterize synthetic datasets. IT-GAN (see Cazenavette, G., et al.: Generalizing Dataset Distillation via Deep Generative Prior, Proceedings of the IEEE/CVF Conference on Computer Vision and Pattern Recognition. pp. 3739-3748, 2023) creates synthetic datasets in a BigGAN's latent space by initially inverting the full training set and then fine-tuning the latent representations based on the distillation objective. Both GLaD and IT-GAN, and similar types of data distillation methods, necessitate complete retraining when distillation ratios change due to their information containers, which require updates when changing the number of images per class (IPC).

For example, GLAD condenses numerous images into a few intermediate feature vectors within the latent space of a GAN, aiding in cross-architecture generalization. However, its distillation algorithm requires adjustments, impacting the distillation ratio.

For another example, DiM (Kai Wang, Jianyang Gu, Daquan Zhou, Zheng Zhu, Wei Jiang, and Yang You. Dim: Distilling dataset into generative model. arXiv preprint arXiv:2303.04707, 2023) tackles distillation algorithm retraining but relies on a two-stage algorithm to optimize generative models for creating training samples per epoch, specifically for a 10-class classification task. However, DiM encounters challenges such as high training costs and limitations in scalability for intricate, high-resolution datasets.

D2M system 100 merges the technical strengths of both DM and MTT. It distills discriminative knowledge from the dataset into the parameter space of generative models, reducing re-distillation expenses and achieving superior performance on standard benchmarks for datasets of varying resolutions, both low and high.

D2M systems disclosed herein provide an improved, more efficient approach by parameterizing the synthetic image dataset within the learnable parameter space of any generative model using a specific framework with an embedding matching module to capture semantic information across different layers of feature extractions based on channel wise attention maps. Unlike GLAD and IT-GAN, whose storage complexity grows linearly with increasing IPCs, the D2M system and framework maintain a constant storage complexity across various distillation ratios.

As described in detail below, an example D2M system can implement one or both of an embedding matching module and a prediction matching module that facilitate the distillation of different types of knowledge into the generative model using suitable matching losses, all geared towards improving classification performance for downstream classification tasks.

Following the distillation stage, the generative model in D2M system can generate training samples or training images for classification tasks with any number of images per class from random noises. Unlike other dataset distillation methods, example embodiments of D2M system 100 eliminate the need for retraining the distillation when changing the distillation ratio, which offers clear advantages in re-distillation efficiency. As a D2M system stores information in the trained generative model rather than in image pixels, it provides much desired scalability to high-resolution (256×256) and large-scale datasets, effective for efficient synthetic data generation and requiring significantly less memory storage than existing data distillation systems.

In one aspect, as further described in detail below, an example D2M system can transfer the knowledge of large-scale datasets into a parameter space of a generative model that can produce informative images for downstream application, including for example, image classification tasks. The D2M data processing is configured to distill various representations from the original, real dataset to provide diverse supervision.

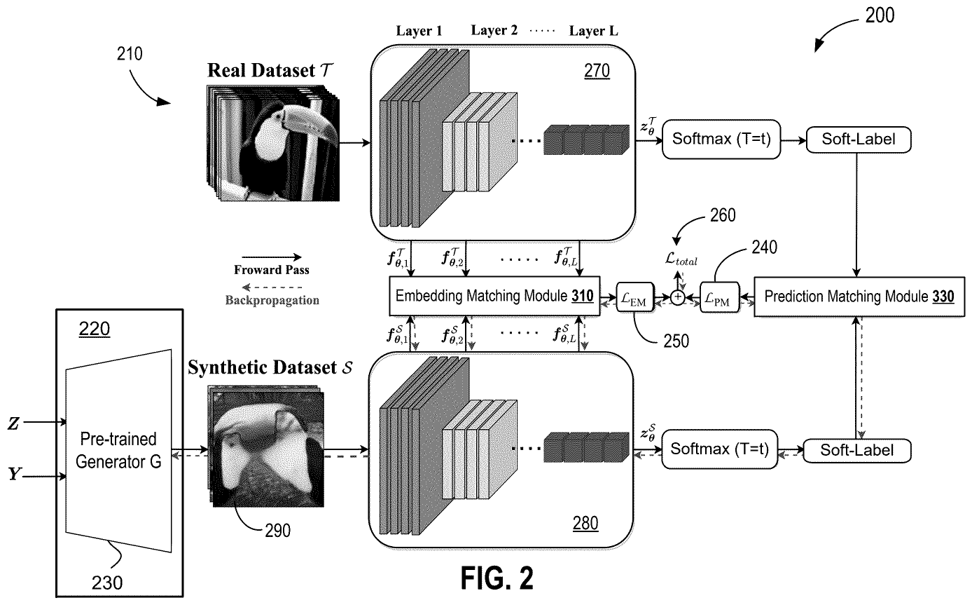

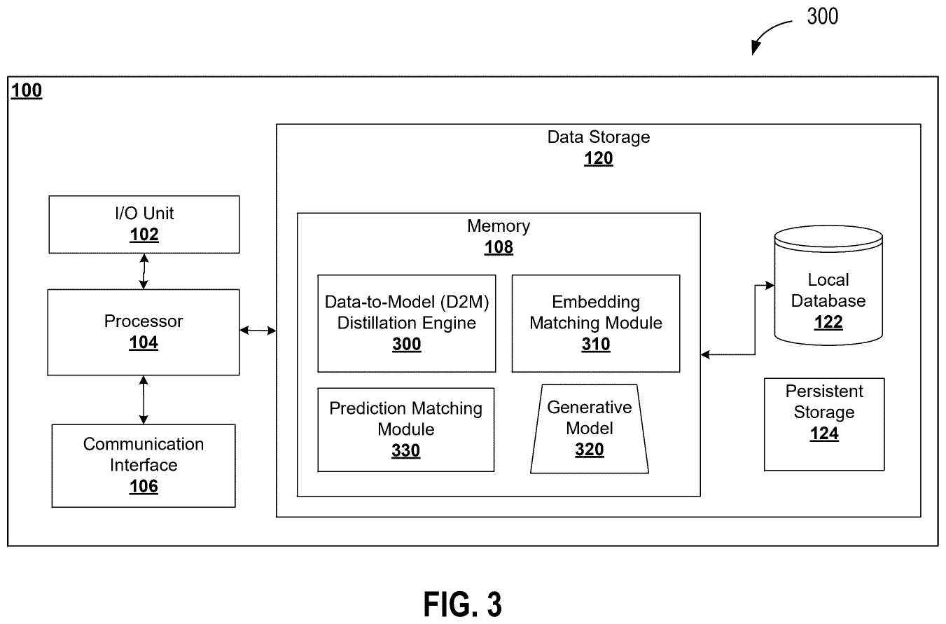

FIGS. 2 and 3 show a simplified D2M framework 200 for efficient data processing and a corresponding schematic block diagram 300 of an example computer system 100 for implementing said D2M framework using a machine learning generative model 220, 320, exemplary of some embodiments.

In FIG. 3, system 100 includes an I/O unit 102, a processor 104, communication interface 106, and data storage 120. The I/O unit 102 can enable system 100 to interconnect with one or more input devices, such as a keyboard, mouse, camera, touch screen and a microphone, and/or with one or more output devices such as a display screen and a speaker.

Data storage 120 including a memory device 108 (also referred to as memory 108), a local database 122, and persistent storage 124. Memory 108 include one or more sets of machine-executable instructions stored thereon, such as for example, D2M distillation engine 300, embedding matching module 310, prediction matching module 330, and a generative model 320.

Processor 104 is configured to execute machine-executable instructions stored in D2M distillation engine 300 to perform processes disclosed herein, including for example, training and updating generative model 320 based on embedding matching module 310 and prediction matching module 330.

System 100 can connect to an interface application installed on one or more devices (not shown) to exchange signals representing user commands or response(s) to said user commands. The interface application can interact with system 100 to exchange data (including control commands) and generates visual elements for rendering and display at user device. The visual elements can represent one or more images, for example.

System 100 can connect to different data sources, including third party sources to receive input data or to transmit other data. For instance, system 100 can receive and transmit asset data from internal and/or external data sources (not shown). The data can be transmitted and received via one or more wired or wireless networks, which may involve different network communication technologies, standards and protocols, for example.

Processor 104 can execute instructions in memory 108 to implement aspects of processes described herein. Processor 104 can execute instructions in memory 108 to configure various components and functions described herein. Processor 104 can be, for example, any type of general-purpose microprocessor or microcontroller, a digital signal processing (DSP) processor, an integrated circuit, a field programmable gate array (FPGA), a reconfigurable processor, or any combination thereof.

Memory 108 may include a suitable combination of any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Data storage devices 120 can include memory 108, databases 122, and persistent storage 124.

Communication interface 106 can enable system 100 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these.

System 100 can be operable to register and authenticate users (using a login, unique identifier, and password for example) prior to providing access to system 100. For example, user authentication process may be handled via an authentication module (not shown).

Data storage 120 may be configured to store information associated with or created by the components in memory 108 and may also include machine executable instructions. Memory 108 may be persistent memory storage. Data storage 120 includes a persistent storage 124 which may involve various types of storage technologies, such as solid state drives, hard disk drives, flash memory, and may be stored in various formats, such as relational databases, non-relational databases, flat files, spreadsheets, extended markup files, etc.

Referring now to FIG. 2, the D2M system 100, as shown in the framework 200, distills the knowledge of large-scale datasets 210 into the parameter space of a pre-trained Generator G 230 through an embedding matching module 310. In some embodiments, a prediction matching module 330, which is optional, is added to system 100 to further refine the Generator G 230 in refinement or training iterations.

D2M system 100 and framework 200 differ from existing data distillation works that directly distill knowledge into raw pixels. In the D2M system 100 and framework 200, the information in the original dataset is transformed into the learnable parameters of a generative model, offering a new path for efficient learning.

In some embodiments, a D2M distillation engine 300 of system 100, during execution, performs steps to distill knowledge from a large-scale training dataset, which may be for example, a real dataset 210 including a plurality of original images, represented by

$$𝒯 = {\{ ( {x}_{i} , {y}_{i} ) \}}_{i = 1}^{\vert 𝒯 \vert} ,$$

with | [symbol] | image-label pairs, into a generative model G 230, which is part of generative model 220, 320. The real dataset 210 may be referred to as the original dataset throughout the disclosure. The learned Generator G 230 can then produce small yet informative training images 290 for the downstream classification tasks. Z and Y represent the random noises and labels, respectively.

In a distillation stage, D2M distillation engine 300 extracts data representing comprehensive knowledge from images in the real dataset [symbol] 210, including data representing one or both of embedded representations and logit prediction, and then distills them into the parameters of a generative model 220, 320. Generative model 220, 320 may include a pre-trained Generator G 230. This procedure refines Generator G 230, through a training process, to synthesize a small yet informative dataset 290

$$𝒮 = {\{ ( {s}_{j} , {y}_{j} ) \}}_{j = 1}^{\vert 𝒮 \vert}$$

that has comparable training power to the real or original dataset [symbol] 210.

Following distillation, the learned generative model 220, 320 can produce new training images from random noises, enabling flexibility in the distillation ratios. These training images can be subsequently deployed in classification tasks, which provides a shorter training time and requires less compute resource power to complete the training for a given machine learning model for image classification tasks. The learned generative model 220, 320 can produce different training images based on different distillation ratios or IPCs, for the original dataset [symbol] 210, without having to be retrained.

A randomly initialized generative model yields noisy outputs, making it challenging to establish meaningful correspondences with real images during the distillation process. Therefore, in some embodiments, the generative model 220, 320 can include a Generative Adversarial Network (GAN) with a generator G 230 and a discriminator D trained (also referred to as refined) using the following standard loss function:

$${min}_{G} {max}_{D} {𝔼}_{x \sim {P}_{𝒯}} [ log D ( x \vert y ) ] + {E}_{z \sim {P}_{Z}} [ log ( 1 - D ( G ( z \vert y ) ) ) ] , \qquad ( 1 )$$

where [symbol] and P_{Z} denote the distributions of real training images and latent vectors, respectively.

In some embodiments, the generative model 220, 320 can include a pre-trained GAN. For example, the generative model 220, 320 can include a pre-trained BigGAN with the default hyperparameters and learning strategy outlined in Brock, A., Donahue, J., Simonyan, K.: Large scale GAN training for high fidelity natural image synthesis, in: International Conference on Learning Representations (2018).

Conventional GANs typically generate images that deviate from the original data distribution and are less informative than real samples for training deep networks. To mitigate this limitation, during a distillation stage, the generative model 220, 320 is trained or refined in a number of iterations. This training or refinement process enables the generative model 220, 320 to synthesize images that are more discriminative and better suited to downstream classification tasks.

In some example embodiments, during the training process, in each iteration, B pairs consisting of random noises Z and labels Y in each batch of random noise image data are selected and fed into the pre-trained generative model 220, 320 to produce synthetic images [symbol] . Meanwhile B real images are randomly selected from the original dataset [symbol] 210 with corresponding labels y.

An example input dataset may include, for example, original dataset 210 represented by

$$𝒯 = {\{ ( {x}_{i} , {y}_{i} ) \}}_{i = 1}^{\vert 𝒯 \vert} ,$$

with | [symbol] | image-label pairs, where xᵢ represents original images and yᵢ represents corresponding labels. In this case, B≤| [symbol] |, where B is the batch size per iteration, and | [symbol] | is the total number of original images processed by system 100 with multiple iterations.

In some embodiments, a model data store (also referred to as model pool) is included in system 100 for extraction of rich representations that are essential for learning. In some embodiments, an embedding matching module is implemented to minimize differences in channel-wise attention maps (at various layers). In some embodiments, a prediction matching is implemented to minimize differences in output predictions between real and generated images. In some other embodiments, both the embedding matching module and the prediction matching module are implemented. The model data store or model pool can include, for example, different neural networks such as Depth-n ConvNets and ResNet-18/32 with different initialization random seeds.

In some embodiments, to improve diversity, one model from the model data store is randomly selected by D2M distillation engine 300 at each iteration to generate an embedding matching model 310 for computing an embedding output for each respective image. For example, D2M framework 200 can include a first neural network model 270 and a second neural network model 280, each of which may a default neural network or may be selected by randomly selected by D2M distillation engine 300 at each iteration.

One or both of first neural network model 270 and second neural network model 280 may include, in some embodiments, a default Convolutional Neural Network (ConvNet) architecture, which may include a Depth-n ConvNet, n blocks precede a fully connected layer, with each block containing a 3×3 convolutional layer (128 filters), instance normalization, Rectified Linear Unit (ReLU) activation, and 2×2 average pooling (stride of 2). The number of blocks can be set or adjusted based on on dataset resolution: e.g., n=3, 4, 5, and 6 for 32×32, 64×64, 128×128, and 256×256, respectively.

For example, through orchestration of D2M distillation engine 300, processor 104 can execute embedding matching module 310 to generate original embedding output for the respective original image and synthetic embedding output for the generated synthetic image, each in a forward pass, using first neural network model 270 and second neural network model 280, respectively.

During each iteration of refinement of the generative model 220, 320, both real and synthetic batches undergo a forward pass using a neural network φ_{θ}(·) 270, 280 with different initializations from a model pool or model store. The neural network 270, 280 can be used by embedding matching module 310 to generate an embedding loss 250. Embedding matching module 310 is implemented for extracting features and predicting classification logits for both real and synthetic images. The neural networks 270, 280 and embedding matching module 310 can help with mitigation of overfitting and offer diverse views for matching tasks.

In some embodiments, during each iteration, neural network φ_{θ}(·) 270, 280 may be a randomly chosen neural network φ_{θ}(·) 270, 280 with different initializations from a model pool or model store. This network can be used by embedding matching module 310, which is implemented for extracting features and predicting classification logits for both real and synthetic images. The model pool can help with mitigation of overfitting and offer diverse views for matching tasks.

In some embodiments, a default ConvNet architecture setting may include three identical convolutional blocks and a linear classifier. Each convolutional block includes a 128-kernel 3×3 convolutional layer, instance normalization, Rectified Linear Unit (ReLU) activation, and 3×3 average pooling with a stride of 2.

In some embodiments, for datasets like Tiny ImageNet (see Le, Y., Yang, X.: Tiny ImageNet Visual Recognition Challenge, CS 231N 7(7), 3, 2015) and ImageNet-1K, adjustments are made by adding a fourth and fifth convolutional block to accommodate higher input resolutions like 128×128 and 256×256, respectively.

The networks 270, 280 can be initialized using normal initialization, for example, as described in He, K., Zhang, X., Ren, S., Sun, J.: Delving deep into rectifiers: Surpassing Human-Level Performance on ImageNet Classification, in: Proceedings of the IEEE international conference on computer vision. pp. 1026-1034, 2015.

In the distillation stage, the generative model 220, 320 can be refined using a stochastic gradient descent (SGD) optimizer with a batch size of B=128 over K=60 epochs while setting the task balance λ and the temperature T to 100 and 4, respectively.

In some embodiments, D2M system 100 employs Stochastic Gradient Descent (SGD) optimization with a fixed learning rate of 0.01 for learning synthetic datasets. It trains datasets with varying numbers of images per class (IPC): specifically, 1, 10, and 50 IPCs. Training of all-resolution synthetic images is carried out over 1000 epochs with a task balance parameter (λ) set at 100.

In some embodiments, an embedding matching module 310 is implemented to capture the representations of the original dataset 210 [symbol] across various layers.

First neural network 270 and second neural network 280 can be used by embedding matching module 310 to generate embedding output data comprising feature maps and predicted logits for each respective image in each respective dataset 210, 290.

For example, network 270, 280 are responsible for extracting features and predicting classification logits for real and synthetic images. Network 270 can be used to generate original embedding output, including feature maps and predicted logits, denoted as

$${ϕ}_{θ} ( 𝒯 ) = [ {f}_{θ , 1}^{𝒯} , … , {f}_{θ , L}^{𝒯} , {z}_{θ}^{T} ] ,$$

for original dataset 210 [symbol] , and network 280 can be used to generate synthetic embedding output including feature maps and predicted logits, denoted as

$${ϕ}_{θ} ( 𝒮 ) = [ {f}_{θ , 1}^{𝒮} , … , {f}_{θ , L}^{𝒮} , {z}_{θ}^{𝒮} ] ,$$

for synthetic dataset 290 S.

The feature map(s)

$${f}_{θ , l}^{𝒯}$$

and logit(s)

$${z}_{θ}^{𝒯}$$

are multi-dimensional arrays obtained or derived from the original dataset [symbol] 210 in the l^{th} and pre-softmax layers of the network, respectively. Similarly, feature map(s)

$${f}_{θ , l}^{𝒮}$$

and logit(s)

$${z}_{θ}^{𝒮}$$

are multi-dimensional arrays obtained or derived from the synthetic dataset S 290 in the l^{th} and pre-softmax layers of the network, respectively.

Embedding matching module 310 aligns the channel-wise attention maps between the real and synthetic sets across different feature extraction layers using am embedding loss function to generate embedding loss [symbol] 250.

In some embodiments, embedding loss [symbol] 250 is generated based on: 1) original embedding loss determined using feature map(s)

$${f}_{θ , l}^{S}$$

for the original images from original dataset [symbol] 210; and 2) synthetic embedding loss determined using feature map(s)

$${f}_{θ , l}^{s}$$

for the synthetic images from synthetic dataset S 290.

In some embodiments, embedding loss [symbol] 250 is formulated as:

$${𝔼}_{θ \sim {P}_{θ}} [ {\sum }_{l = 1}^{L} {‖ {𝔼}_{𝒯} [ {\tilde{f}}_{θ , l}^{𝒯} ] - {𝔼}_{𝒮} [ {\tilde{f}}_{θ , l}^{𝒮} ] ‖}^{2} ] , \qquad ( 2 )$$

where P_{θ} is the distribution of neural network parameters and

$${\tilde{f}}_{θ , l}^{𝒯}$$

is defined as:

$${\tilde{f}}_{θ , l}^{𝒥} := \{ \begin{matrix}{a}_{θ , l}^{𝒥} & if l = 1 , ⋯ , L - 1 \\ {f}_{θ , l}^{𝒥} & if l = L ,\end{matrix} \qquad ( 3 )$$

in which

$${a}_{θ , l}^{𝒥}$$

represents the vectorized channel attention maps in the l^{th} layer for the original dataset [symbol] 210.

In some embodiments, in a similar manner,

$${\tilde{f}}_{θ , l}^{𝒮}$$

can be defined tor the synthetic dataset S 290. For example,

$${\tilde{f}}_{θ , l}^{𝒮}$$

can be defined as;

$${\tilde{f}}_{θ , l}^{𝒮} := \{ \begin{matrix}{a}_{θ , l}^{𝒮} & if l = 1 , ⋯ , L - 1 \\ {f}_{θ , l}^{𝒮} & if l = L ,\end{matrix}$$

in which

$${a}_{θ , l}^{𝒮}$$

represents the vectorized channel attention maps in the l^{th} layer for the synthetic dataset S 290.

In some embodiments, each training image is characterized or represented through the use of channel-wise attention maps created by different layers. These channel-wise attention maps highlight the most discriminative regions of the input image, revealing the network's focus across various layers, including early and intermediate layers, for obtaining information at low- and mid-level representations. The last layer of feature extraction in the neural network contains the highest-level abstract information. This embedding matching module 310 has been shown to effectively capture semantic information from the input data.

In some embodiments, a mean square error loss is implemented to match the vectorized versions of the final feature maps between real and synthetic data. The embedding matching module 310 is implemented to use the most discriminative regions of feature maps using the concept of attention, differing significantly from pure feature matching approaches like CAFE. In cases where ground-truth data distributions are unavailable, the expectation term in Equation (2) above may be empirically estimated.

Although [symbol] 250 effectively approximates large-scale real data distribution, its matching loss primarily minimizes the mean feature distance within each batch without explicitly constraining the diversity of synthetic images. Therefore, in some embodiments, a complementary loss, such as a prediction matching loss 240, may be implemented as a regularizer to provide more specific supervision. This regularization is an optional subprocess, and is implemented to promote similarity in the output probability predictions of the trained generative model 220, 320 between the original dataset [symbol] 210 and the synthetic dataset S 290, directly influencing the results of any downstream classification task.

In some embodiments, the prediction matching module 330 is implemented using logit-based matching to minimize the differences in the softened output predictions between real and generated synthetic images by Generator G 230. The soft-label predictions introduce additional information to the generative model that can be helpful for classification tasks.

In some embodiments, prediction matching loss [symbol] 240 is generated based on: 1) original prediction loss determined using prediction logits

$${z}_{θ}^{𝒥}$$

for the original images from original dataset [symbol] 210; and 2) synthetic embedding loss determined using prediction logits

$${z}_{θ}^{s}$$

for the synthetic images from synthetic dataset S 290.

In some embodiments, for an input dataset including original dataset 210 represented by

$$𝒯 = {\{ ( {x}_{i} , {y}_{i} ) \}}_{i = 1}^{\vert 𝒯 \vert}$$

where xᵢ represents images and yᵢ represents corresponding labels, prediction matching loss [symbol] 240 can then be determined as follows:

$${𝔼}_{θ \sim {P}_{θ}} [ {\sum }_{i = 1}^{B} KL ( σ ( \frac{{z}_{θ}^{{x}_{i}}}{T} ) , σ ( \frac{{z}_{θ}^{{s}_{i}}}{T} ) ) ] , \qquad ( 4 )$$

where KL stands for Kullback-Leibler divergence, σ(·) denotes the softmax function, and

$${z}_{θ}^{{x}_{i}} and {z}_{θ}^{{s}_{i}}$$

are the prediction logits for real and synthetic images sharing the same label yᵢ, respectively. The temperature hyperparameter T is used to generate soft-label predictions while regulating the entropy of the output distribution.

In some embodiments, the total training loss for the generative model 220, 320 is formulated as a training loss [symbol] 260, which may be, for example, an augmented Lagrangian of the two mentioned losses. The parameters of the generative model 220, 320 can be learned by solving the following optimization problem using SGD:

$${G}^{*} = arg {min}_{G} ( {ℒ}_{EM} + {λℒ}_{PM} ) , \qquad ( 5 )$$

where λ serves as a Lagrangian multiplier to balance the gradients of [symbol] and [symbol] .

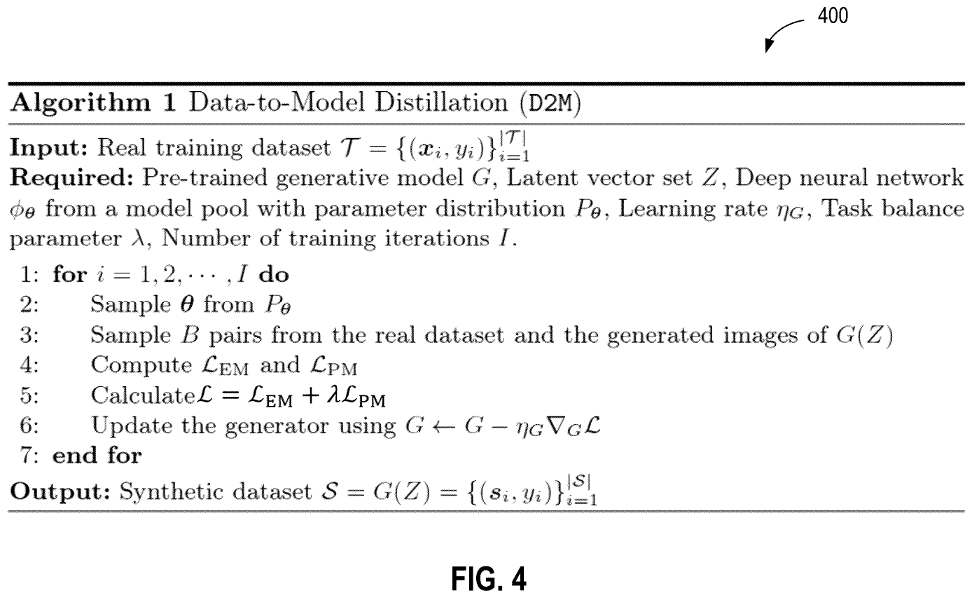

FIG. 4 illustrates an example set of pseudo code 400 for an example training process performed by system 100 to refine the generative model 220, 320, in accordance with some embodiments. The input data set may include a real or original training dataset

$$𝒯 = {\{ ( {x}_{i} , {y}_{i} ) \}}_{i = 1}^{\vert 𝒯 \vert}$$

comprising | [symbol] | image-label pairs.

System 100 may include a stored pre-trained generative model including a Generator G, Latent vector set Z, a deep neural network φ_{θ} from a model pool with parameter distribution P_{θ}, learning rate η_{G}, task balance parameter λ, number of training iterations I. For each iteration i, where i=1, 2, . . . , I, D2M engine 300 is configured to: samples θ from P_{θ}, randomly selects B pairs from original training dataset [symbol] and the generated images of G(Z); compute [symbol] and [symbol] using Equations (2) and (4) above; calculate [symbol] = [symbol] +λ [symbol] ; and update the generator G to G* in the generative model 220, 320 based on G*←G−η_{G}∇_{G} [symbol] .

The final output, after completion of all I iterations in the training or refinement, includes a synthetic dataset

$$𝒮 = G ( Z ) = {\{ ( {s}_{i} , {y}_{i} ) \}}_{i = 1}^{\vert 𝒮 \vert} ,$$

which can be used as a reduced-size training set for a machine learning application for image classification task.

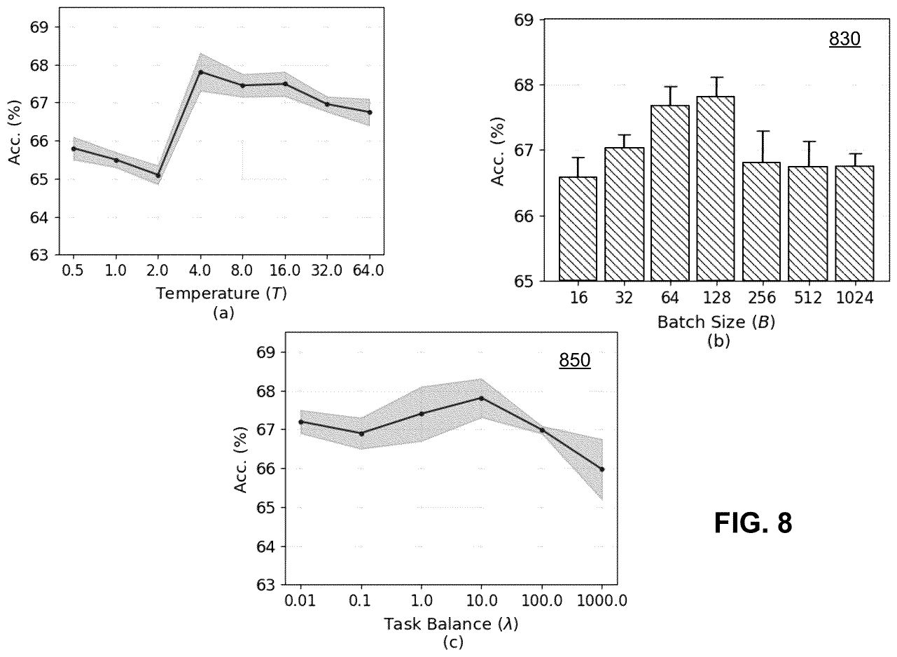

In some embodiments, soft label predictions enrich the information in the generated synthetic dataset. A temperature parameter T is implemented to control the entropy of the output distribution while generating soft label predictions. As shown in Graph 810 in FIG. 8, increasing the T value improves performance of D2M system 100 up to a certain point (T=4). A lower temperature emphasizes only maximal logits, while a higher value flattens the distribution, focusing on different logits uniformly. Tuning the softmax temperature allows soft labels to reveal extra knowledge like class relationships for training, enabling information flow across classes.

In some embodiments, the generative model 220, 320 is trained by minimizing a linear combination of embedded-based and prediction-based matching losses, as expressed in Equation (5) above. The parameter λ serves as the regularizing coefficient, determining the balance between the losses.

In Graph 850 in FIG. 8, different values of λ (ranging from 0.01 to 1000) are plotted on the CIFAR-10 dataset with IPC10 to assess its sensitivity. A default value of λ=10, for example, can yield highest accuracy. Values that are too high, such as 1000, reduce the effectiveness of embedding matching, resulting in a loss of informative knowledge. Conversely, values too small for λ appear to compromise regularization and impede the distillation of discriminative label knowledge, which is beneficial for classification tasks.

Conventional generative models strive to produce real-looking images but may lack the informative value of real images for training due to inherent information loss. Therefore, during the distillation stage, generator G 230 is refined, in a training process, with different loss function configurations and improvements of 10.3% and 7.9% are observed for [symbol] and [symbol] , respectively, on CIFAR-10 dataset with IPC10. This enhancement is attributed to the transfer of informative and discriminative knowledge for classification tasks. Moreover, combining [symbol] and [symbol] led to a remarkable 12.7% improvement.

In some embodiments, different batch sizes are experimented for refining generator G 230 during the distillation stage, as shown in Graph 830 in FIG. 8. A default batch size B=128 over K=60 epochs may be implemented, while setting the task balance λ and the temperature T to 100 and 4, respectively.

In some embodiments, batch size B can range within 16 to 1024 on ConvNet-3. In some embodiments, a batch size B=128 yields the highest accuracy, as illustrated in Graph 830 in FIG. 8. Smaller batch sizes perform poorly due to their insufficient representativeness for feature matching and limited supervision from the original dataset in each iteration. In contrast, excessively large batch sizes, while providing more information, introduce optimization challenges and lead to a performance decrease. Regardless of the batch size value, Generator G 230 in D2M system 100 remains completely stable during training. In terms of solving the optimization problem, increasing the batch size can complicate the tractability of the optimization problem and result in a more difficult optimization problem.

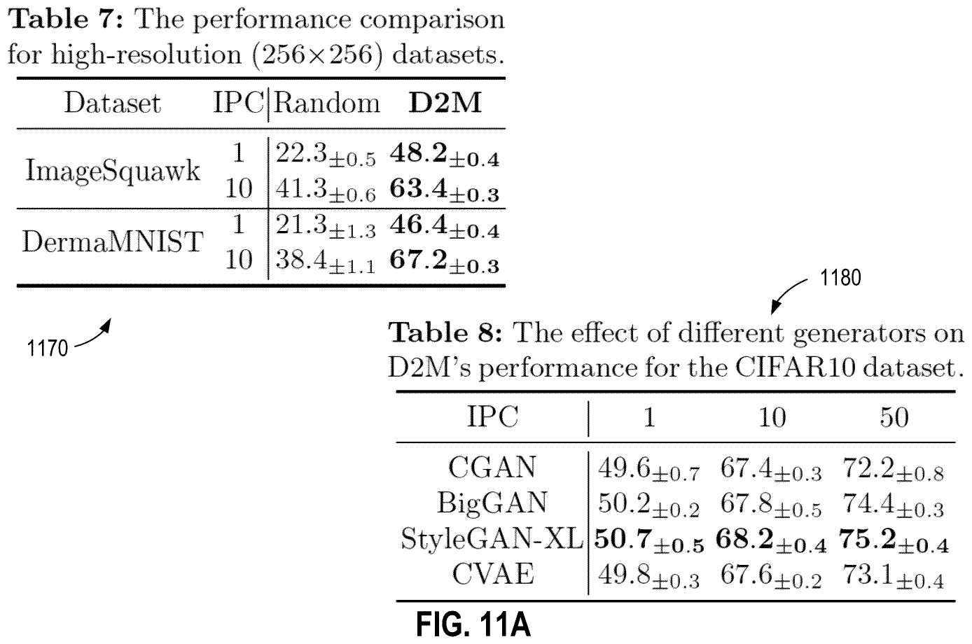

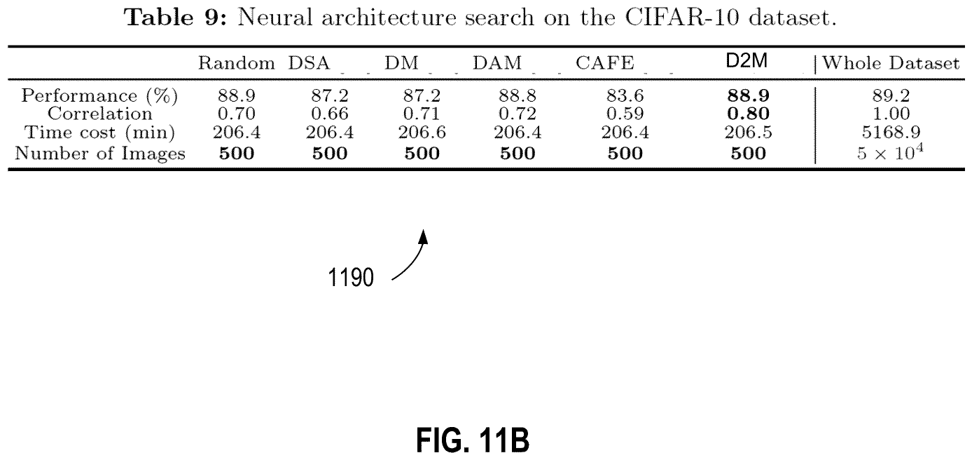

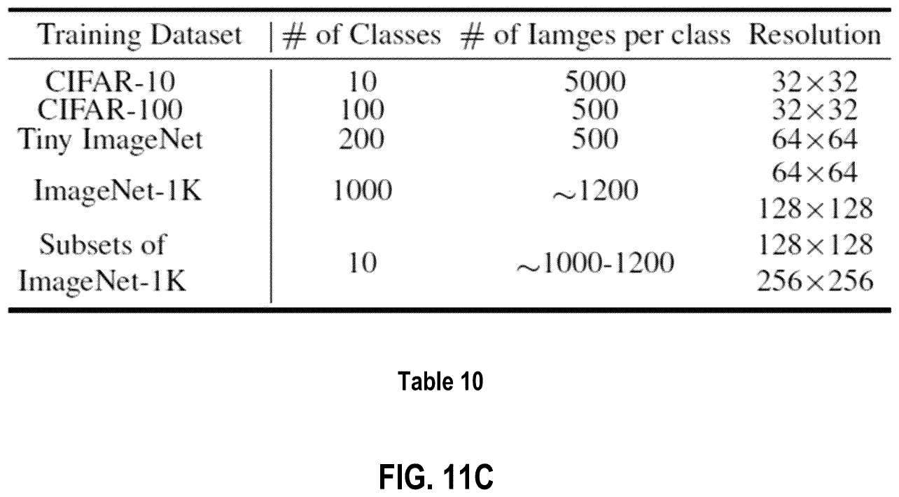

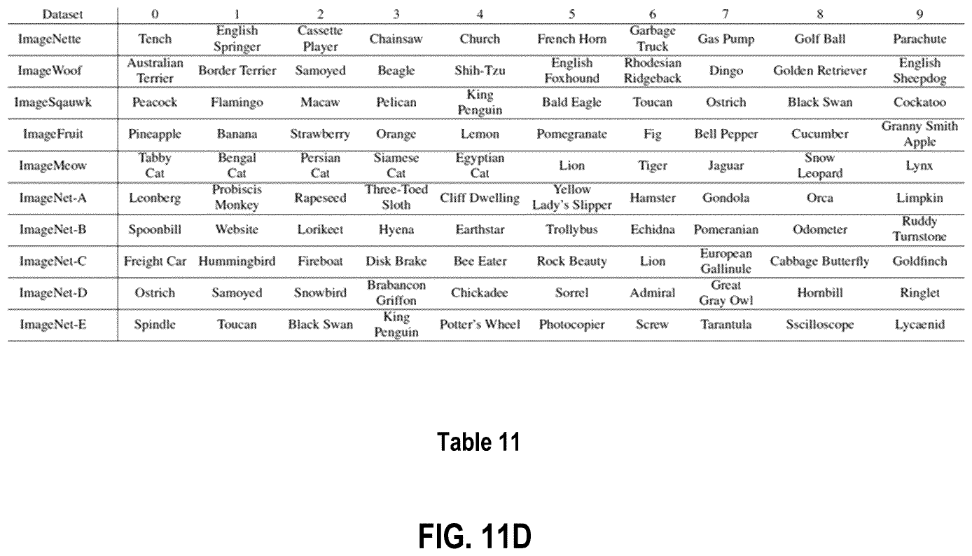

In some embodiments, different pre-trained generators are implemented as part of generative model 220, 320 in system 100, by deploying BigGAN, CGAN, StyleGAN-XL, and a conditional VAE (CVAE) model (see Child, R.: Very Deep VAEs Generalize Autoregressive Models and Can Outperform Them on Images, International Conference on Learning Representations 2021) on CIFAR-10 dataset with IPC1, 10, and 50. Table 8 (1180) in FIG. 11A demonstrates that all models effectively synthesize images for classification. For example, BigGAN is chosen as an example default generator due to its balance of performance and computational efficiency.

In some embodiments, D2M system 100 includes a discriminator in the distillation process, which may increase the computational graph size. Experiments conducted on CIFAR-10 IPC1 with three configurations produces three distillation loss: matching loss only (50.2%), matching loss with balanced discriminator loss (50.9%), and matching loss with large discriminator loss (43.8%). These results suggest that a strong discriminator can harm performance, while using discriminator loss as regularization improves results, likely due to reduced catastrophic forgetting. Thus, the matching loss is primarily responsible for making the images better suited for downstream training.

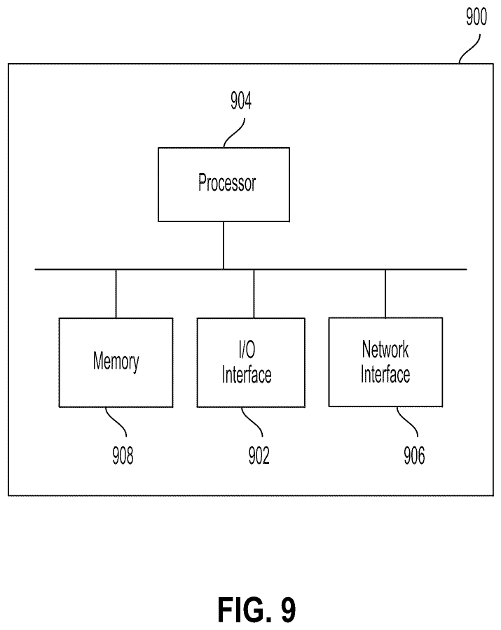

FIG. 9 is a schematic diagram of an example computing device 900 that implements a system (e.g., one or more components of system 100), in accordance with an embodiment. As depicted, computing device 900 includes one or more processors 904, memory 908, one or more I/O interfaces 902, and one or more network interfaces 906.

Each processor 904 may be, for example, a microprocessor or microcontroller, a digital signal processing (DSP) processor, an integrated circuit, a field programmable gate array (FPGA), a reconfigurable processor, a programmable read-only memory (PROM), or any combination thereof.

Memory 908 may include a suitable combination of any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Memory 908 may store code executable at processor 904, which causes training system to function in manners disclosed herein.

Memory 908 includes a data storage device or hardware. In some embodiments, the data storage device includes a secure datastore. In some embodiments, the data storage device stores received data sets, such as textual data, image data, or other types of data.

Each I/O interface 902 enables computing device 900 to interconnect with one or more input devices, such as a keyboard, mouse, camera, touch screen and a microphone, or with one or more output devices such as a display screen and a speaker.

Each network interface 906 enables computing device 900 to communicate with other components, to exchange data with other components, to access and connect to network resources, to serve applications, and perform other computing applications by connecting to a network such as network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these.

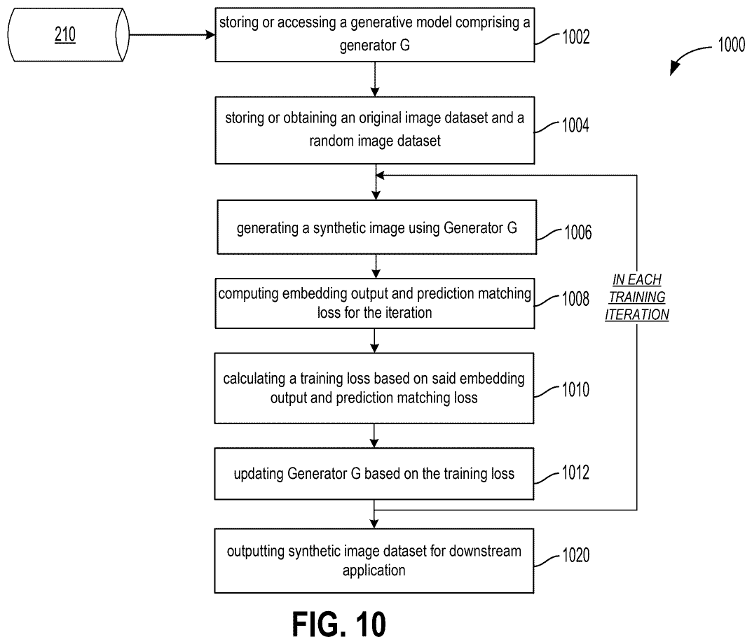

The methods and processes disclosed herein, including the process described below in view of FIG. 10, may be implemented using a system that includes multiple computing devices 900. The computing devices 900 may be the same or different types of devices.

Each computing devices may be connected in various ways including directly coupled, indirectly coupled via a network, and distributed over a wide geographic area and connected via a network (which may be referred to as “cloud computing”).

For example, and without limitation, each computing device 900 may be a server, network appliance, set-top box, embedded device, computer expansion module, personal computer, laptop, personal data assistant, cellular telephone, smartphone device, UMPC tablets, video display terminal, gaming console, electronic reading device, and wireless hypermedia device or any other computing device capable of being configured to carry out the methods described herein.

FIG. 10 shows an example process 1000 performed by a system such as D2M system 100 in FIG. 3 for training or refining a machine learning model for image data distillation, in accordance with some embodiments. In some embodiments, process 1000 is executed by processor 104 based on machine-readable instructions stored in memory 108, as orchestrated by the D2M distillation engine 300 in D2M system 100.

At operation 1002, the processor 104 stores or accesses a machine learning generative model 220, 320. The generative model 220, 320 may include a pre-trained generator G 230.

At operation 1004, processor 104 stores or obtains an original image dataset 210 comprising a plurality of original or real images, and a random image dataset comprising a plurality of random noise images and corresponding labels.

In some embodiments, original image dataset [symbol] 210 includes a plurality of original images, represented by

$$𝒯 = {\{ ( {x}_{i} , {y}_{i} ) \}}_{i = 1}^{\vert 𝒯 \vert} ,$$

with | [symbol] | image-label pairs. In multiple iterations, system 100 processes | [symbol] | images from original image dataset [symbol] 210 to train or refine the generative model 220, 320.

The random image dataset may include random noises (random images) Z and labels Y, respectively. During each iteration in the training process, B image-label pairs comprising random noises Z and labels Y in each batch of random noise image data are selected and fed into generator G 230 in generative model 220, 320 to produce synthetic images [symbol] .

During the same iteration, B real images are randomly selected from the original dataset 210 [symbol] with corresponding labels Y concurrently for refining generator G 230 and generative model 220, 320.

Operations 1006 to 1012 are steps to refine the generative model 220, 320 during a distillation stage. An example embodiment of system 100 may be implemented with several default parameters, including for example, a batch size of B=128 over K=60 epochs while setting a task balance λ and a temperature T to 100 and 4, respectively.

For each iteration from a plurality of iterations, where the total number of the plurality of iterations is equal to the number of batch size for one training epoch: at operation 1006, processor 104 causes the generator G 230 to generate a synthetic image, which is part of synethc image dataset 290, based on a respective random image and a corresponding label from random image dataset; at operation 1008, processor 104 computes, for the iteration, an embedding output [symbol] 250 using embedding matching module 310; at operation 1010, processor 104 computes a training loss [symbol] 260 based on embedding output [symbol] 250; and at operation 1010, processor 104 updates Generator G 230 based on the training loss [symbol] 260.

In some embodiments, for each iteration, at operation 1008, processor 104 may be configured to: compute, for the interation, a prediction matching loss [symbol] 240 using prediction matching module 330.

In some embodiments, at operation 1010, processor 104 computes the training loss [symbol] 260 based on embedding output [symbol] 250 and the prediction matching loss [symbol] 240.

After the completion of all iterations in an epoch, processor 104 may continue training based on the total number of epochs, and once the entire training is done during distillation stage, processor 104 at operation 1020 outputs a set of synthetic images for downstreaming application, such as training of a machine learning model for image classification tasks, using the much smaller synthetic image dataset.

As part of operation 1008, in some embodiments, processor 104 computes, for the iteration, said embedding output [symbol] 250 using an embedding matching module 310 implemented to capture the representations of the original dataset 210 [symbol] and synethic image dataset across various layers.

For example, through orchestration of D2M distillation engine 300, processor 104 can generate a synthetic embedding output for the generated synthetic image and an original embedding output for the respective original image in a forward pass.

During each iteration of refinement of the generative model 220, 320, both real and synthetic batches undergo a forward pass using a randomly chosen neural network φ_{θ}(·) with different initializations from a model pool or model store. This network can be part of embedding matching module 310, which is implemented for extracting features and predicting classification logits for both real and synthetic images. The model pool can help with mitigation of overfitting and offer diverse views for matching tasks.

In some embodiments, a model data store (also referred to as model pool) is included in system 100 for extraction of rich representations that are essential for learning. One or both of embedding matching and prediction matching modules are implemented, in some embodiments, to minimize differences in channel-wise attention maps (at various layers) and output predictions between real and generated images, respectively. The model data store or model pool can include, for example, different neural networks such as Depth-n ConvNets and ResNet-18/32 with different initialization random seeds.

In some embodiments, to improve diversity, one model from the model data store is randomly selected by D2M distillation engine 300 at each iteration to generate an embedding matching model 310 for computing an embedding output for each respective image. For example, in a Depth-n ConvNet, n blocks precede a fully connected layer, with each block containing a 3×3 convolutional layer (128 filters), instance normalization, ReLU activation, and 2×2 average pooling (stride of 2). The number of blocks depends on dataset resolution: n=3, 4, 5, and 6 for 32×32, 64×64, 128×128, and 256×256, respectively. The networks can be initialized using normal initialization.

The network in embedding matching module 310 generates embedding output data comprising feature maps and predicted logits for each respective image in each dataset. For example, the network in embedding matching module 310 generates original embedding output for the original or real images, denoted as

$${ϕ}_{θ} ( 𝒯 ) = [ {f}_{θ , 1}^{𝒯} , … , {f}_{θ , L}^{𝒯} , {z}_{θ}^{𝒯} ] ,$$

for the original dataset 210 [symbol] , as well as synthetic embedding output for the synthetic images, denoted as

$${ϕ}_{θ} ( 𝒮 ) = [ {f}_{θ , 1}^{𝒮} , … , {f}_{θ , L}^{𝒮} , {z}_{θ}^{𝒮} ] ,$$

for the synthetic dataset 290 S.

The feature map

$${f}_{θ , l}^{𝒯}$$

and logit

$${z}_{θ}^{𝒯}$$

are multi-dimensional arrays obtained from the original dataset 210 in the l^{th} and pre-softmax layers of the network, respectively. Similarly, feature map

$${f}_{θ , l}^{𝒮}$$

and logits

$${z}_{θ}^{𝒮}$$

are multi-dimensional arrays obtained or derived from the synthetic dataset 290 S.

The embedding matching module 310 aligns the channel-wise attention maps between the real and synthetic sets across different feature extraction layers, generating an embedding output [symbol] 250 using an embedding loss function formulated as:

$${𝔼}_{θ ∼ {P}_{θ}} [ {\sum }_{l = 1}^{L} {‖ {E}_{𝒯} [ {\tilde{f}}_{θ , l}^{𝒯} ] - {𝔼}_{𝒮} [ {\tilde{f}}_{θ , l}^{𝒮} ] ‖}^{2} ] ,$$

where P_{θ} is the distribution of neural network parameters and

$${\tilde{f}}_{θ , l}^{𝒯}$$

is defined as:

$${\tilde{f}}_{θ , l}^{𝒯} := \{ \begin{matrix}{a}_{θ , l}^{𝒯} & ifl = 1 , … , L - 1 \\ {f}_{θ , L}^{𝒯} & ifl = L ,\end{matrix}$$

in which

$${a}_{θ , l}^{𝒯}$$

represents the vectorized channel attention maps in the l^{th} layer for the original dataset 210 [symbol] .

In a similar manner,

$${\tilde{f}}_{θ , l}^{𝒮}$$

can be defined for the synthetic dataset 290 S.

In some embodiments, each training image is characterized or represented through the use of channel-wise attention maps created by different layers. These channel-wise attention maps highlight the most discriminative regions of the input image, revealing the network's focus across various layers, including early and intermediate layers, for obtaining information at low- and mid-level representations. The last layer of feature extraction in the neural network contains the highest-level abstract information. This embedding matching module 310 has been shown to effectively capture semantic information from the input data.

In some embodiments, a mean square error loss is implemented to match the vectorized versions of the final feature maps between real and synthetic data. The embedding matching module 310 is implemented to use the most discriminative regions of feature maps using the concept of attention.

In some embodiments, as part of operation 1008, processor 104 computes a prediction matching loss [symbol] 240 for said iteration using the prediction matching module 330 based on the synthetic embedding output and the original embedding output.

Although [symbol] 250 effectively approximates large-scale real data distribution, its matching loss primarily minimizes the mean feature distance within each batch without explicitly constraining the diversity of synthetic images. Therefore, in some embodiments, a complementary loss in the form of prediction matching loss [symbol] 240 is implemented as a regularizer to provide more specific supervision. This regularization promotes similarity in the output probability predictions of the trained generative model 220, 320 between the original dataset 210 [symbol] and the synthetic dataset 290 S, directly influencing the results of any downstream classification task.

In some embodiments, the prediction matching module 330 is implemented using logit-based matching to minimize the differences in the softened output predictions between real and generated synthetic images by Generator G 230. The soft-label predictions introduce additional information to the generative model that can be helpful for classification tasks.

In some embodiments, prediction matching loss [symbol] 240 can then be written as follows:

$${𝔼}_{θ ∼ {P}_{θ}} [ {\sum }_{i = 1}^{B} K L ( σ ( \frac{{z}_{θ}^{{x}_{i}}}{T} ) , σ ( \frac{{z}_{θ}^{{s}_{i}}}{T} ) ) ] ,$$

where KL stands for Kullback-Leibler divergence, σ(·) denotes the softmax function, and

$${z}_{θ}^{{x}_{i}} and {z}_{θ}^{{s}_{i}}$$

are prediction logits for real and synthetic images sharing the same label yᵢ, respectively. The temperature hyperparameter T is used to generate soft-label predictions while regulating the entropy of the output distribution.

In some embodiments, the synthetic embedding output comprises a feature map for the respective synthetic image and the original embedding output comprises a feature map for the respective original image.

In some embodiments, the embedding loss is computed based on the feature map for the respective synthetic image and the feature map for the respective original image.

In some embodiments, D2M system 100 may include a neural network 270, 280 implemented to align respective channel-wise attention maps between the original image dataset and a synthetic image dataset comprising the synthetic images generated by the generator network.

In some embodiment, neural network 270, 280 is randomly selected from a model pool or model data store.

In some embodiments, the embedding matching module generates the embedding losses across different feature extraction layers using a loss function and the neural network.

In some embodiments, the embedding matching module uses the most discriminative regions of the feature maps, based on the respective channel-wise attention maps, to align feature distributions between the original image dataset and the synthetic image dataset generated by the generator network.

In some embodiments, the synthetic embedding output comprises a predicted logit for the respective synthetic image and the original embedding output comprises a predicted logit for the respective original image.

In some embodiments, the prediction matching loss is computed based on the predicted logit for the respective synthetic image and the predicted logit for the respective original image.

In some embodiments, example process 1000 includes randomly selecting a neural network implemented to minimize differences in soft-label output predictions, by the generator network, between the output predictions based on the original image dataset and the output predictions based on the synthetic images generated by the generator network.

In some embodiments, during each said iteration, example process 1000 includes randomly selecting a neural network from a model data store comprising neural networks with different initializations for the embedding matching module.

Referring now to details of operation 1010, in some embodiments, the total training loss for the generative model 220, 320, formulated as a training loss [symbol] 260, is computed based on said embedding output [symbol] 250 and said prediction matching loss [symbol] 240.

For example, an augmented Lagrangian of embedding output [symbol] 250 and prediction matching loss [symbol] 240 may form training loss [symbol] 260. The parameters of the generative model 220, 320 can be learned by solving the following optimization problem using SGD:

$${G}^{*} = arg {min}_{G} ( {ℒ}_{E M} + λ {ℒ}_{P M} ) ,$$

where λ serves as a Lagrangian multiplier to balance the gradients of [symbol] and [symbol] .

In some embodiments, example process 1000 includes, after completing the plurality of iterations for refining the machine learning generative model: obtaining a first distillation ratio; generating a first set of training images using the trained generator network based on the original image dataset and the first distillation ratio; and storing or processing the first set of training images for downstream classification tasks.

In some embodiments, example process 1000 includes, after the generation of the first set of training images: obtaining a second distillation ratio different from the first distillation ratio; generating a second set of training images using the trained generator network, without retraining the generator network, based on the original image dataset and the second distillation ratio; and storing or processing the second set of training images for downstream classification tasks.

In some embodiments, generation of a third set of training images using the trained generator network can be performed after generation of said second set of training images without retraining the generator network, based on a distillation ratio different from the first and second distillation ratio.

Comparison with Other Generative-Based Data Distillation Methods

Recent generative-based dataset distillation methods typically distill large-scale datasets into the latent space of a specific GAN model. For example, GLAD utilizes various intermediate feature spaces of StyleGAN-XL to characterize synthetic datasets. IT-GAN creates synthetic datasets in a BigGAN's latent space by initially inverting the full training set and then fine-tuning the latent representations based on the distillation objective. Both GLAD and IT-GAN necessitate complete retraining when distillation ratios change due to their information containers, which require updates when changing the IPC.

Kernel-based approaches, such as KIP and FRePo, employ significantly larger neural networks compared to other baseline methods. Specifically, KIP uses a larger model with a width of 1024 for evaluation, as opposed to the 128 used by other approaches. KIP also incorporates an additional convolutional layer compared to other methods. In the case of FRePo, it utilizes a distinct model that doubles the number of filters when the feature map size is halved. Furthermore, FRePo employs batch normalization instead of instance normalization.

In contrast, D2M system, framework and methods disclosed herein provide a novel approach by parameterizing the synthetic dataset within the learnable parameter space of any generative model using a carefully designed framework. Unlike GLAD and IT-GAN, whose storage complexity grows linearly with increasing IPCs, the disclosed D2M framework and system maintain a constant storage complexity across various distillation ratios.

To demonstrate the efficacy of said D2M system and framework, following description includes empirical data illustrating the contrast between D2M, GLAD and IT-GAN, showing that D2M framework as disclosed herein consistently outperforms GLAD and IT-GAN in all cases.

### Experiments and Empirical Data

The experiments are conducted across diverse image classification datasets with varying resolutions and label complexity.

Table 10 in FIG. 11C provides an overview of various datasets used in some of the experiments conducted using example embodiments of D2M system 100 and other distillation systems. The CIFAR dataset, widely recognized in the field of low-resolution computer vision, comprises images of common objects rendered in 32×32 pixels. This dataset is divided into two parts: CIFAR-10, containing 10 broad categories, and CIFAR-100, featuring 100 more detailed categories. Each part consists of 50,000 training images and 10,000 for testing. The CIFAR-10 dataset classifies images into distinct categories such as “airplane”, “car”, “bird”, “cat”, “deer”, “dog”, “frog”, “horse”, “ship”, and “truck”. The Tiny ImageNet dataset is derived from the larger ImageNet-1K and includes 200 classes, with 100,000 training images and 10,000 testing images, all downsized to 64×64 pixels.

In contrast, the more extensive ImageNet-1K dataset encompasses 1,000 categories, boasting over 1.2 million training images and 50,000 testing images. To align with the specifications of Tiny ImageNet, the ImageNet-1K images are resized to 64×64 pixels. The Tiny ImageNet and ImageNet-1K datasets present a higher level of complexity compared to CIFAR-10/100 (see Krizhevsky, A., et al.: Learning Multiple Layers of Features From Tiny Images, 2009) due to their broader class range and increased image resolution.

The experiments described herein incorporate high-resolution images, specifically the 128×128 pixel versions of ImageNet-1K and its subsets. While previous dataset distillation studies focused on subsets categorized by themes such as birds, fruits, and cats, the experiments described herein take a more comprehensive approach by including several subsets like ImageNette (assorted items), ImageWoof (dog breeds), ImageSquawk (bird species), ImageFruit, and ImageMeow (cat species). This demonstrates the robustness of the D2M system across a broad range of datasets. Table 11 in FIG. 11D shows a comprehensive list of the ImageNet classes within each subset.

Application of D2M system 100 can be scaled to process images with higher resolutions, specifically 256×256 for the Image-Squawk dataset and medical imaging DermaMNIST. The DermaMNIST makes use of the HAM10000 dataset, which is a comprehensive collection of dermatoscopic images depicting various common pigmented skin lesions. This dataset includes 10,015 dermatoscopic images classified into seven different diseases, posing a multi-class classification challenge. To facilitate model training and evaluation, the images are divided into training, validation, and test sets with a 7:1:2 ratio.

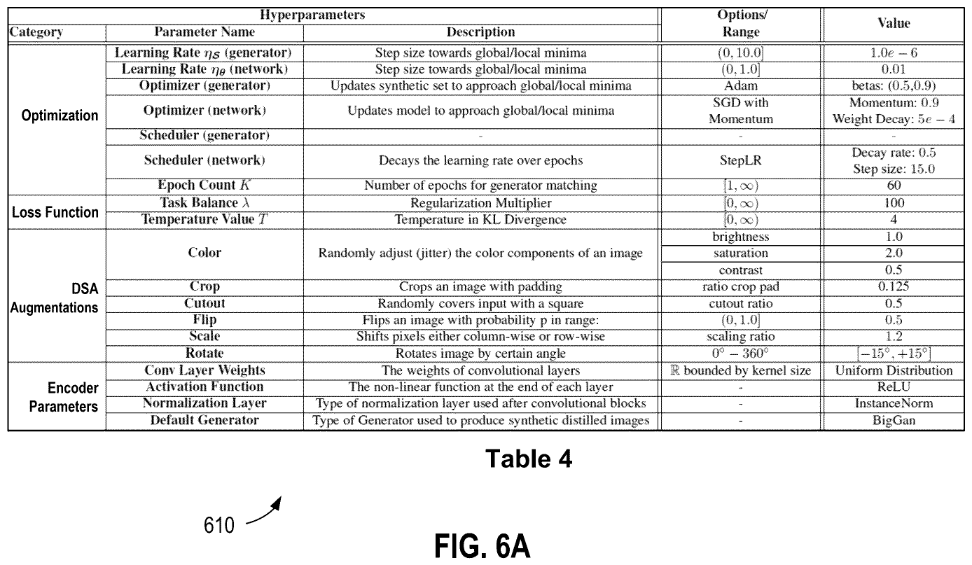

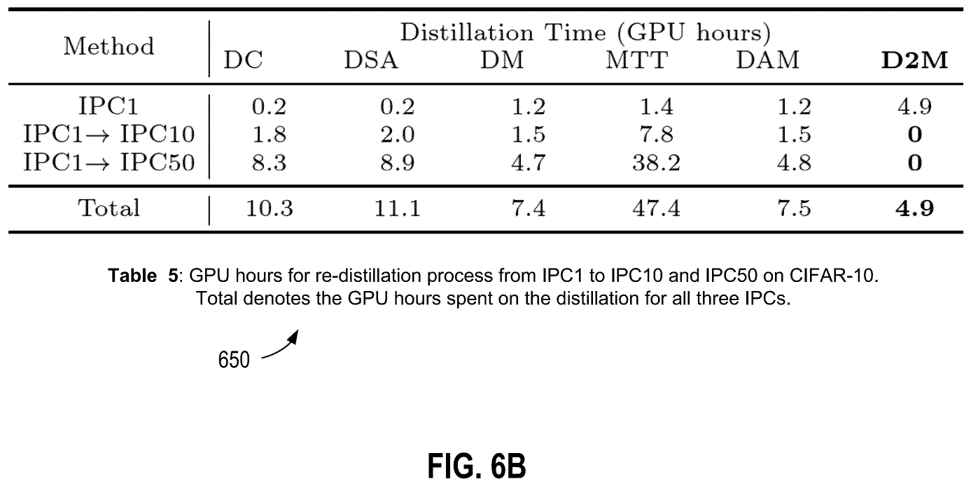

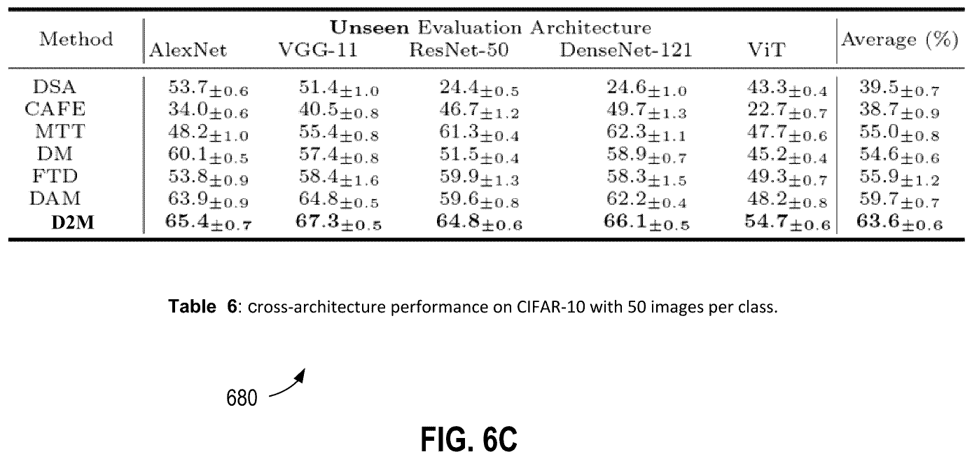

Table 4 (610) in FIG. 6A illustrates example hyperparameters employed the example embodiments used to conduct the experiments. Uniform hyperparameter settings are maintained throughout all experiments unless otherwise noted. Specifically, a SGD optimizer is implemented with a learning rate of 1e-6 during the distillation stage and a learning rate of 0.01 when training neural network models during the evaluation phase. For low-resolution datasets, a 3-layer ConvNet architecture, while for medium- and high-resolution datasets, 4-layer and 5-layer ConvNet architectures are used, respectively. Across all experiments, a mini-batch size of 128 real images was used for training over 60 epochs. A set of differentiable augmentations are applied during both the distillation and evaluation phases.

In some embodiments, D2M system and method are executed based on CIFAR-10/100 for low-resolution data. The Tiny ImageNet and ImageNet-1K datasets are resized to 64×64 for medium-resolution ones. For high-resolution data (128×128), ImageNet-1K and its subsets, ImageNette, ImageWoof, ImageSquawk, ImageFruit, and ImageMeow are used, each emphasizing specific categories such as assorted objects, dog breeds, birds, fruits, and cat breeds.

The 10-class ImageNet-1K subsets (ImageNet-[A, B, C, D, E]) are also used, through the evaluation performance of a pre-trained ResNet-50 on ImageNet-1K. Finally, the D2M system and method are applied to the medical imaging domain, focusing on high-resolution 256×256 images in DermaMNIST. This dataset features dermatoscopic images of typical pigmented skin lesions.

D2M system uniquely allows the dynamic generation of images for training. To ensure fairness with conventional studies and methods, the end-to-end latency for training each model is measured and recorded on the given dataset at a particular IPC. When evaluating the D2M system, images are generated on-the-fly during downstream model training, ensuring that the total time for both generating and training matches the latency constraints set by previous works. This approach explores a tradeoff between model training and image generation on the fly during evaluation.

Apart from dynamic generation of images, during the experiments, the same ConvNet networks and optimizers are used across all systems for valid comparison. The computational costs during distillation in GPU hours and the number of learnable parameters are also quantified. For fairness and reproducibility, publicly available datasets of baselines and train models are deployed using experimental settings.

In the example embodiment executed for experiments, a pre-trained BigGAN with the default hyperparameters and learning settings described above is implemented as part of generative model 220, 320. During the distillation stage, generative model 220, 320 is refined using the SGD optimizer with a batch size of B=128 over K=60 epochs while setting the task balance λ and the temperature T to 100 and 4, respectively. Two RTX A-6000 GPUs with 50 GB of memory are part of the hardware setup.

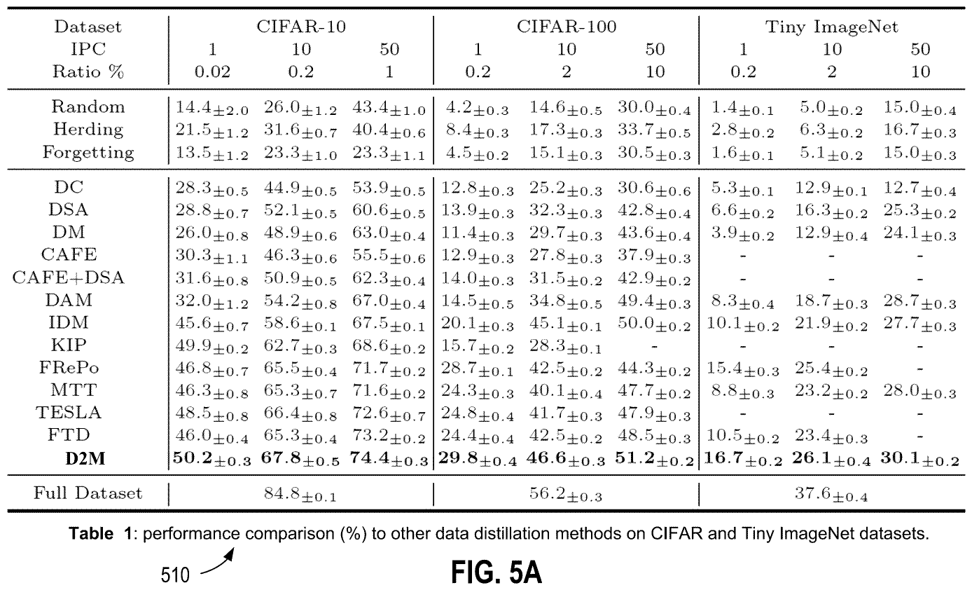

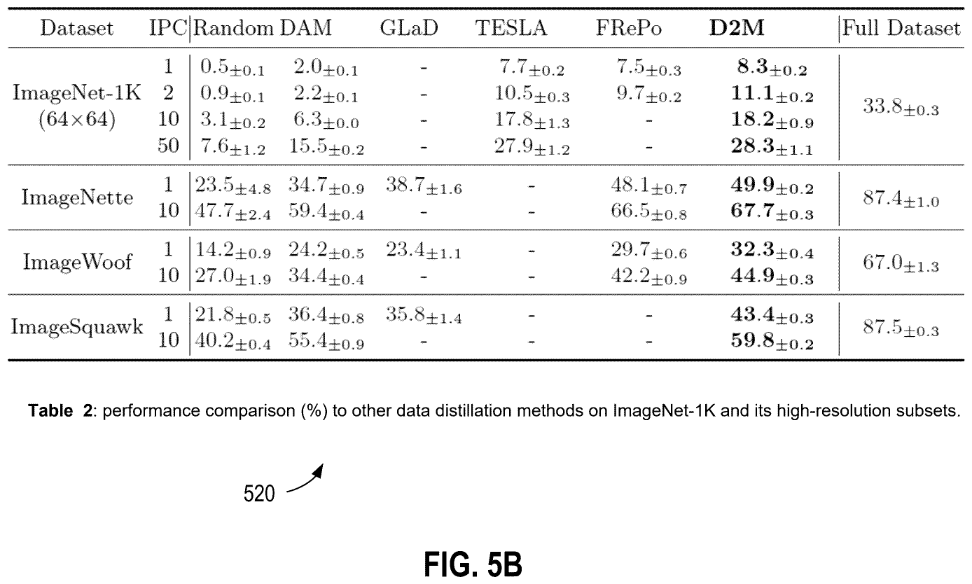

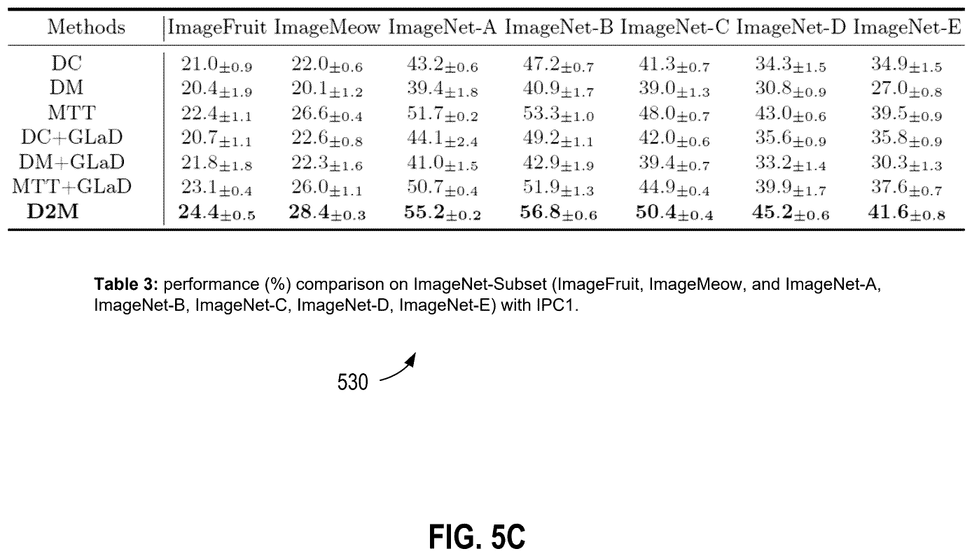

In the experiments conducted, 12 dataset distillation systems including D2M system 100 are each used to generate a respective training dataset, with three coreset selections, for CIFAR-10/100 and Tiny ImageNet datasets, and the results are shown in Table 1 (510) shown in FIG. 5A.

As can be seen in Table 1, D2M system 100 consistently outperforms all other systems across different settings for the low- and medium-resolution datasets. Specifically, it achieves up to 88% of CIFAR-10's upper bound performance with only 1% of its training data and up to 70% of the upper bound with 2% of Tiny ImageNet's training data. ConvNet is used for distillation and evaluation. These results highlight the D2M system's robustness for data-efficient learning and its ability to distill informative knowledge for improved classification task performance.

ImageNet-1K and its subsets are more challenging than the CIFAR-10/100 and Tiny ImageNet datasets for data distillation due to their complex label spaces and higher resolutions. Consequently, memory and time constraints prevented previous data distillation works from scaling up to ImageNet-1K at high resolution. However, D2M overcomes this by distilling information from the original dataset into the generative model's parameters rather than relying on complex raw pixels. This enables D2M to generate synthetic 128×128 ImageNet-1K images, outperforming Random system by a significant margin up to 19.1%.

Performance comparison (%) to other data distillation systems on ImageNet-1K and its high-resolution subsets are illustrated in Table 2 (520) in FIG. 5B, including on ImageNette (assorted objects), ImageWoof (dog breeds), and ImageSquawk (birds) datasets, all with a resolution of 128×128. As shown, D2M system 100 outperforms other data distillation systems with the same model architecture across all settings. Notably, D2M outperforms FRePo, on the ImageWoof by more than 2.7%.

This improvement stems from the fact that D2M effectively distills essential information from the original dataset into the generative model through channel-wise attention map matching and softened output prediction alignment.

To further evaluate D2M system, different data distillation methods including D2M are run on ImageNet-A to ImageNet-E, as well as ImageFruit and ImageMeow (cat breeds). Table 3 (530) in FIG. 5C presents an analysis of performance between D2M and GLAD when applied to various data distillation techniques, namely DC, DM, and MTT. In each case, a synthetic dataset is distilled with one image per class and then evaluated it on the Depth-5 ConvNet. The results show D2M's superiority across all experimental settings.

Furthermore, D2M system 100 can scale to higher resolutions, specifically datasets with a resolution of 256×256. To that end, experiments are conducted on two datasets: ImageSquawk and DermaMNIST. The results, shown in Table 7 (1170) in FIG. 11A, demonstrate superior performance of D2M system 100 across both datasets, surpassing Random by a significant margin.

IT-GAN generates synthetic datasets in a generative model's latent space. This is done by initially inverting the entire training set into the latent space and then fine-tuning the latent representations based on the distillation objective. IT-GAN does not reduce the number of synthesized images; they remain equal to the original dataset count. This differs from the typical aim of dataset distillation.

For a fair comparison with D2M, a small subset (IPC10) of the IT-GAN-generated data (created with BigGAN) are taken as the “distilled dataset”. This subset is then evaluated using ConvNet-3, comparing the results with D2M. IT-GAN achieved a 59.7% accuracy performance on CIFAR-10, a decrease of 8.1% compared to D2M. This finding suggests that the loss function configuration in D2M system effectively distills more informative knowledge into the generative model, aiding downstream classification tasks. It is also worth noting that, unlike D2M, both GLAD and IT-GAN require retraining of the distillation stage when there is a change in IPC or the distillation ratio.

DiM represents a concurrent approach in the realm of dataset distillation. In DiM, a two-stage distillation process is designed specifically for 10-class datasets. Initially, they train the generative model from scratch and subsequently incorporate a distillation loss to minimize differences in knowledge at the penultimate layer between real and synthetic images. In contrast, D2M implements a single-stage distillation applicable to any dataset, leveraging the novel matching modules to incorporate attention maps from intermediate layers and soft output predictions (i.e., dark knowledge).

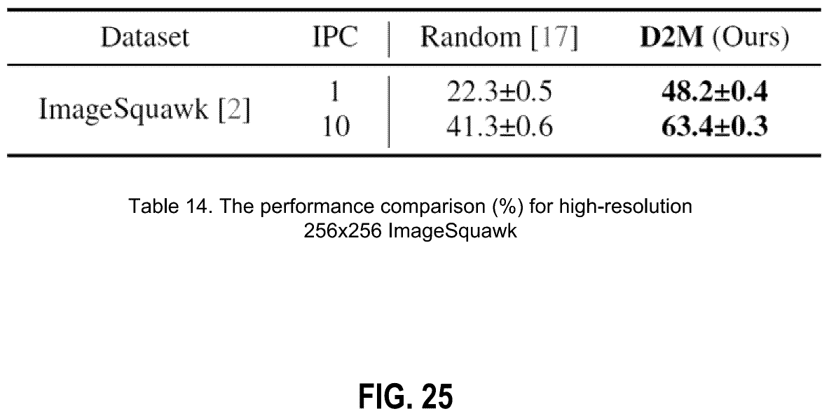

In some embodiments, to further supplement high-resolution performance, an example embodiment of D2M system 100 is executed based on images from ImageSquawk dataset, extended to include images at a resolution of 256×256. Table 14 in FIG. 25 demonstrates superior performance for IPC 1 and 10 when compared to both the random baseline and results by D2M system at a resolution of 128 pixels.

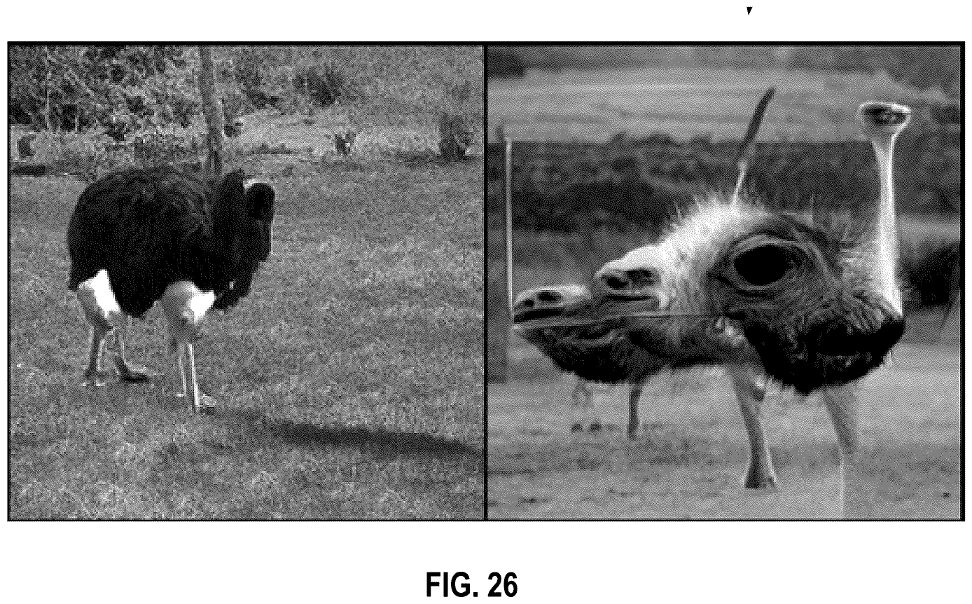

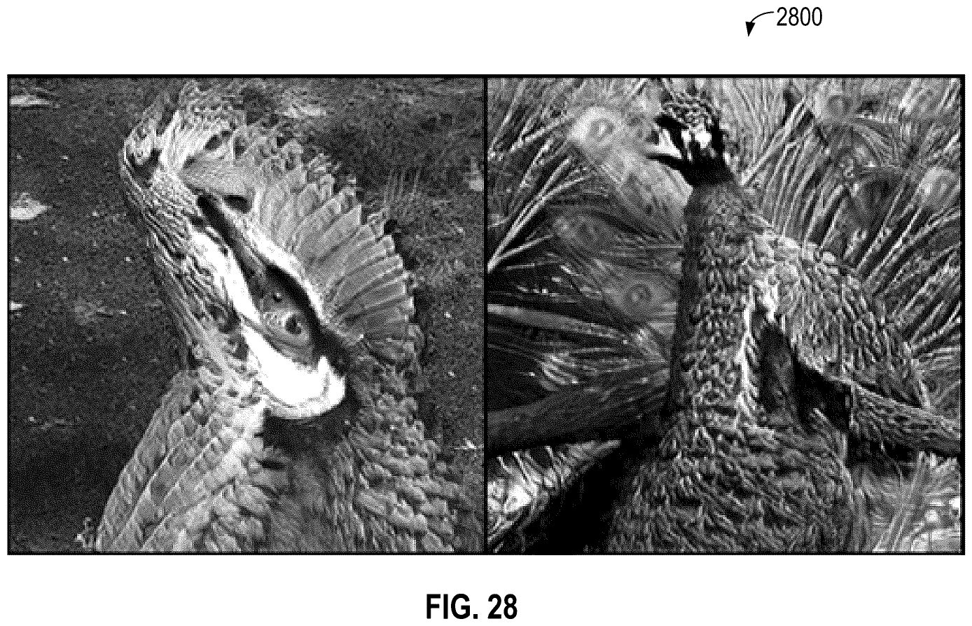

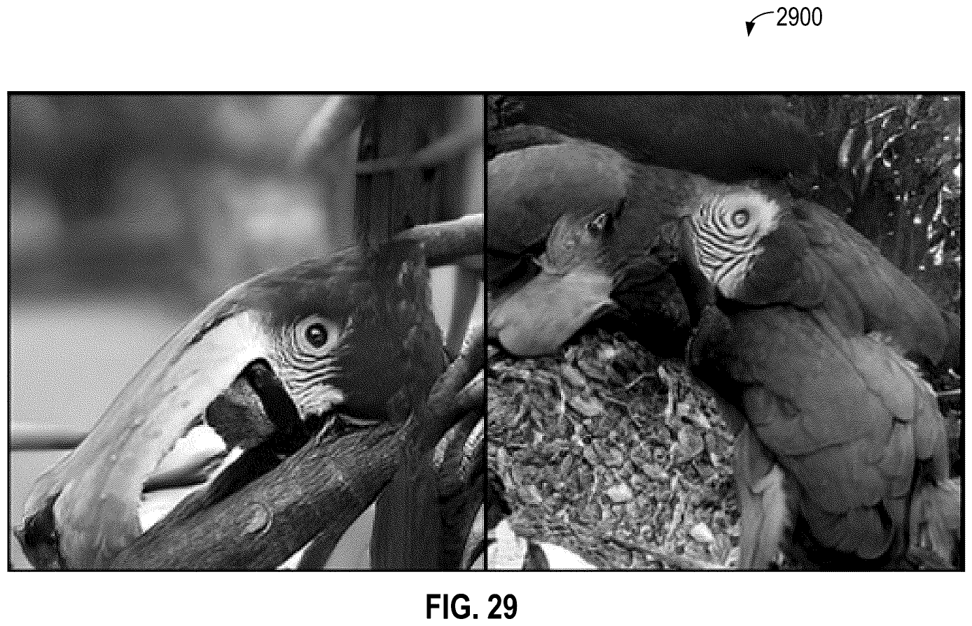

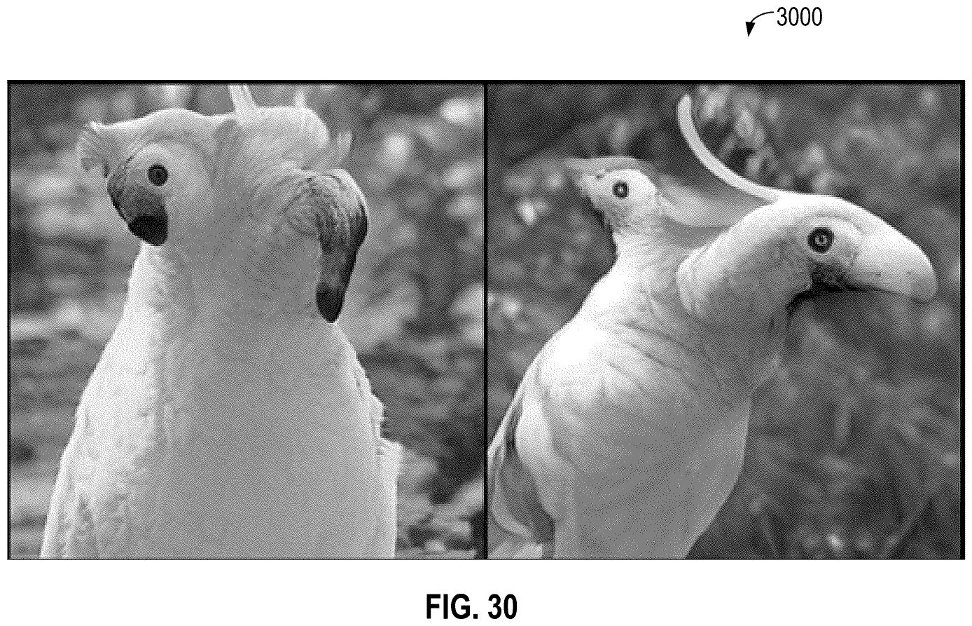

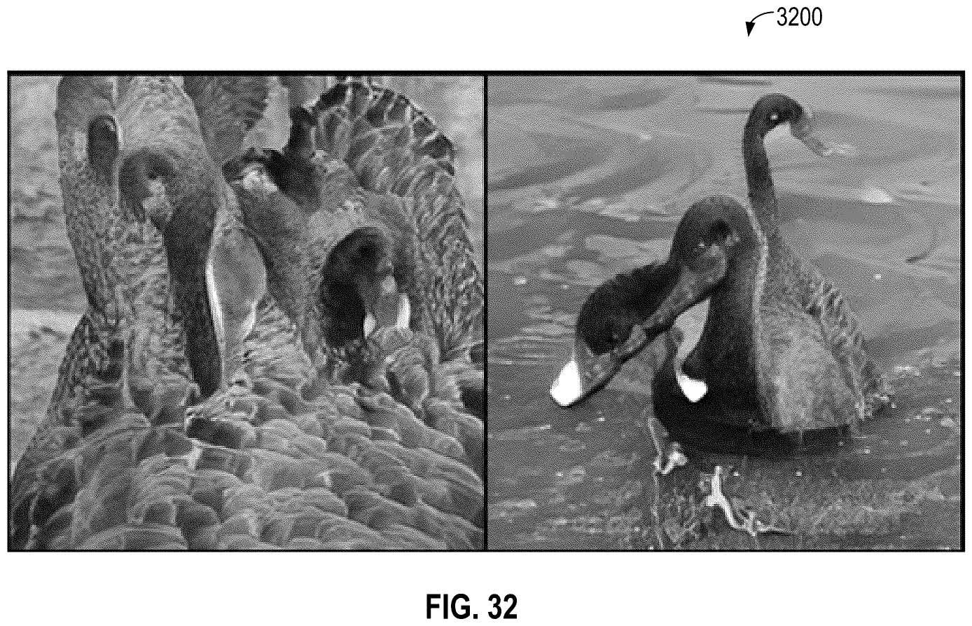

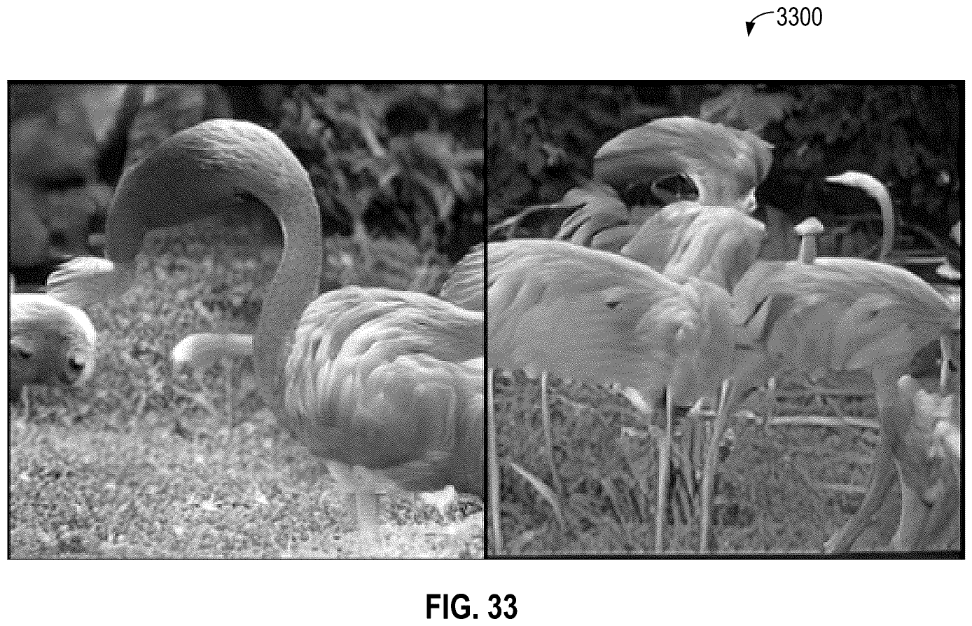

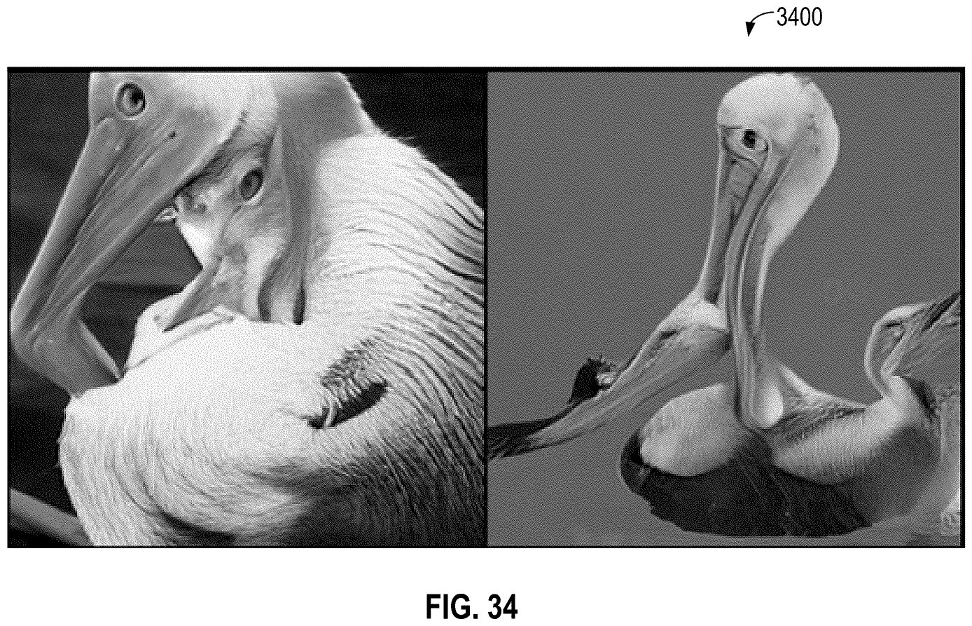

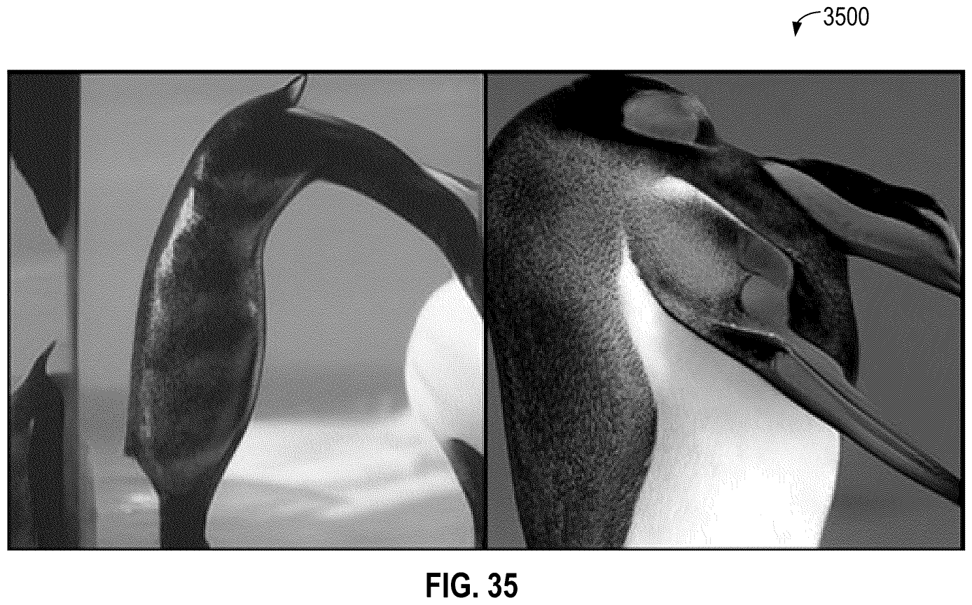

FIGS. 26 to 35 each illustrates a pair of images 2600, 2700, 2800, 2900, 3000, 3100, 3200, 3300, 3400, 3500 for a respective class of images generated by example embodiment of D2M system 100 based on images from ImageSquawk dataset at 256×256 resolution. The generated images in FIGS. 26 to 35 each shows images from: ostrich class 2600, eagle class 2700, peacock class 2800, macaw class 2900, cockatoo class 3000, toucan class 3100, black swan class 3200, flamingo class 3300, pelican class 3400, and penguin class 3500.

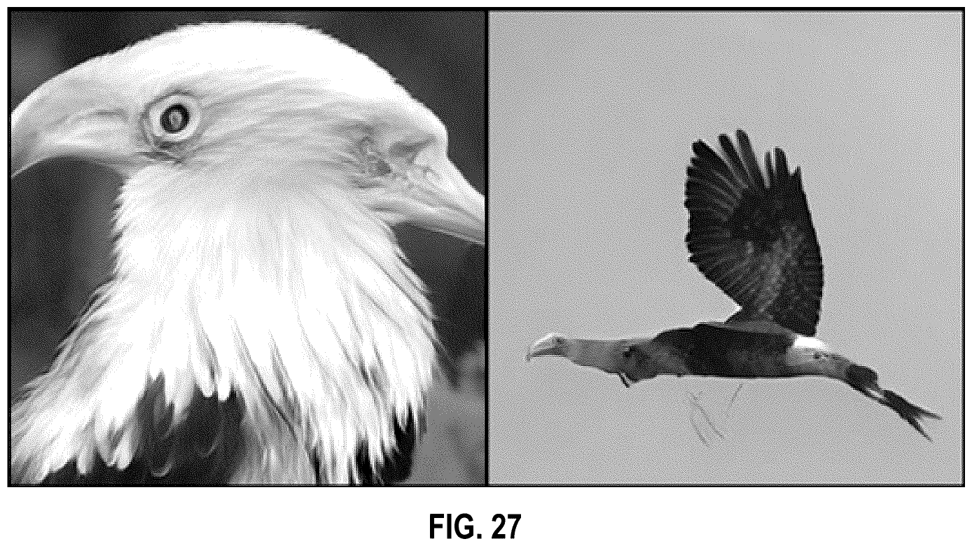

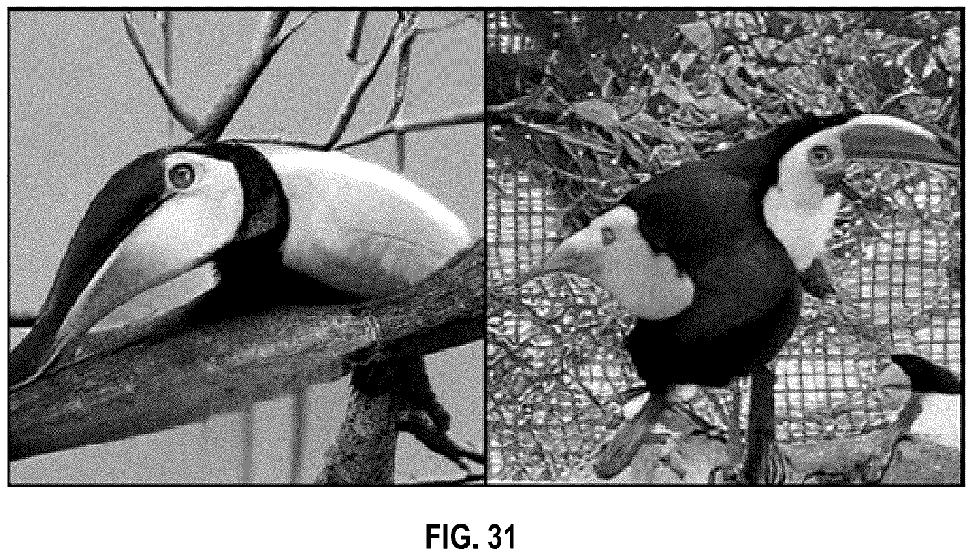

As illustrated in high-resolution images presented in FIGS. 26 to 35, the higher resolution of 256×256 pixels enhances object clarity and feature richness, while the matching modules and loss functions implemented in D2M system 100 can preserve properties of the original dataset. Notable improvements can be observed, such as the enhanced details of multiple heads in the eagle class shown in pair of images 2700 in FIG. 27 and the two-facing beaks in the toucan class in pair of images 3100 in FIG. 31.

### Distillation Cost Analysis

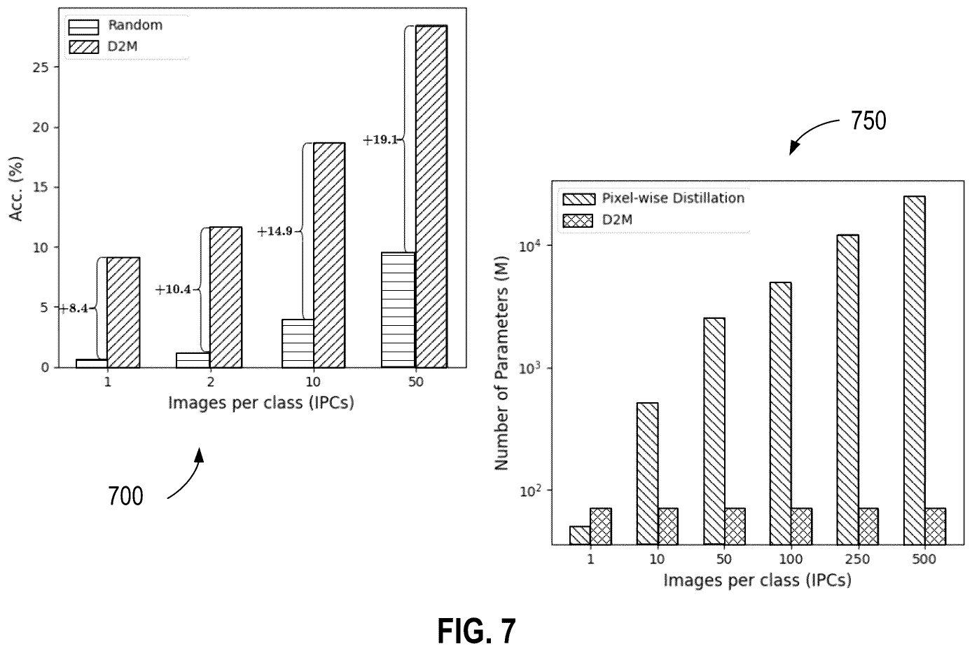

In efficient learning, computational cost is a key consideration during the distillation. When a significant amount of computing resource is required to distill a large dataset to a smaller dataset one for downstream application such as image classification, the overall computational efficiency is compromised. Re-distillation cost in terms of GPU hours for D2M versus other systems is shown in Table 5 (650) in FIG. 6B, and Graphs 700, 750 in FIG. 7 show performance comparison in terms of accuracy in percentage and count of parameters on 128×128 ImageNet-1K dataset, respectively, for D2M versus pixel-wise distillation method. When IPCs change, other non-D2M systems require dataset re-distillation, incurring substantial computational expenses and increasing GPU hours, as seen in FIG. 6B.

In contrast, D2M conducts optimization on generative models' parameters rather than raw pixels, requiring only a single distillation for varying IPCs. This precludes the need for repeated distillation, saving up to 42.5 GPU hours. Additionally, while the number of learnable parameters in pixel-wise data distillation increases with dataset size and resolution, D2M keeps the cost unchanged across all IPCs, saving up to 35× for IPC50, as shown in FIG. 7.

In addition, distillation costs for each individual IPC setting are explored. As there is always a trade-off between performance and computational demands, FTD is used as a reference point. FTD is recognized as one of the top-tier methods in terms of performance for pixel-wise dataset distillation. The GPU hours required by both FTD and D2M during the distillation process on CIFAR-10 across IPC settings of 1, 10, and 50 are recorded.

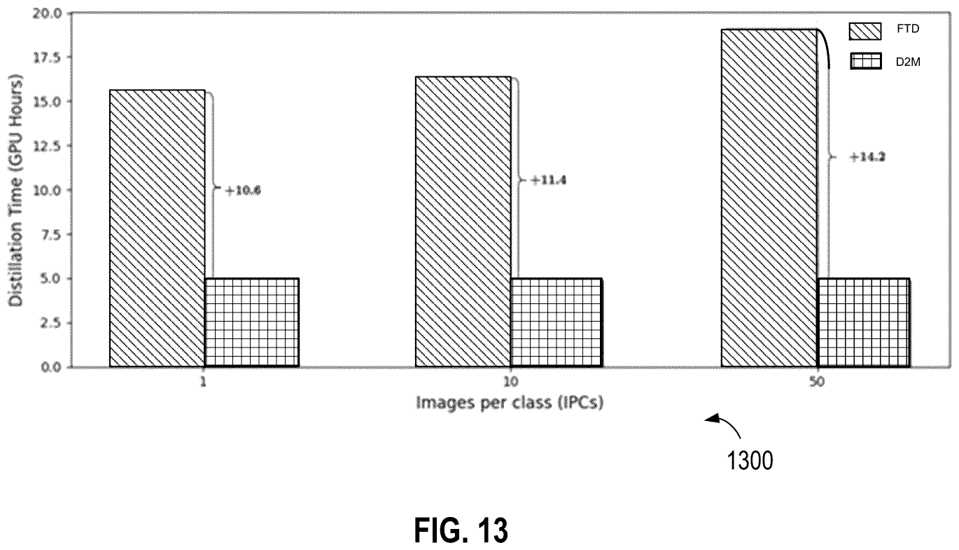

As depicted in chart 1300 in FIG. 13, D2M's GPU hour requirements for distillation remain consistent across different IPCs, which is due to the fact that D2M system is configured to distill knowledge from a real dataset into the parameters of the generative model rather than the raw pixels, and this process is independent of the number of images per class used for distillation. In contrast, in the case of FTD, computational costs increase as IPC is increased. D2M system 100 consistently outperforms FTD in terms of performance and computational costs, regardless of the IPC settings, as shown in FIG. 13, demonstrating that the GPU hours of the distillation time for FTD and D2M on CIFAR-10 with different IPCs.

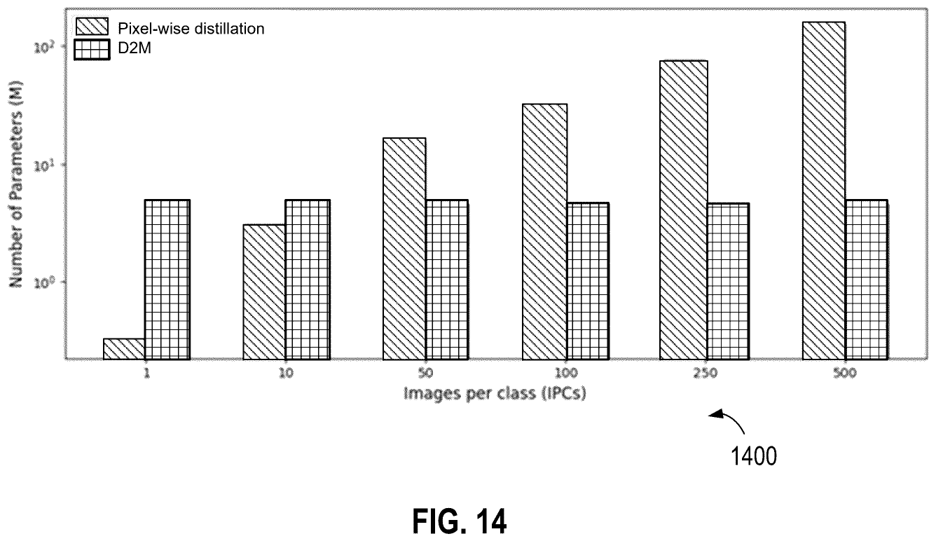

The same advantage of D2M system shows for the number of learnable parameters. It can be observed that for images dataset ImageNet-1K, D2M outperforms all pixel-wise dataset distillation methods in terms of the count of learnable parameters across most IPCs. To further evaluate this, the number of learnable parameters trained on less complex datasets like CIFAR-100 are compared. As illustrated in chart 1400 in FIG. 14, which shows the number of learnable parameters on 32×32 resolution CIFAR-100 with different IPCs for small IPCs, pixel-wise distillation methods exhibit a small advantages over D2M system. However, the number of images per class is increased, D2M significantly outperforms pixel-wise distillation by a considerable margin, especially with IPC settings higher than 20. It can be concluded that D2M excels in computational efficiency and performance when working with complex and high-resolution datasets such as ImageNet-1K or Tiny ImageNet. In addition, for simpler datasets like CIFAR-10/100, D2M remains at the forefront in terms of performance, regardless of the IPCs.

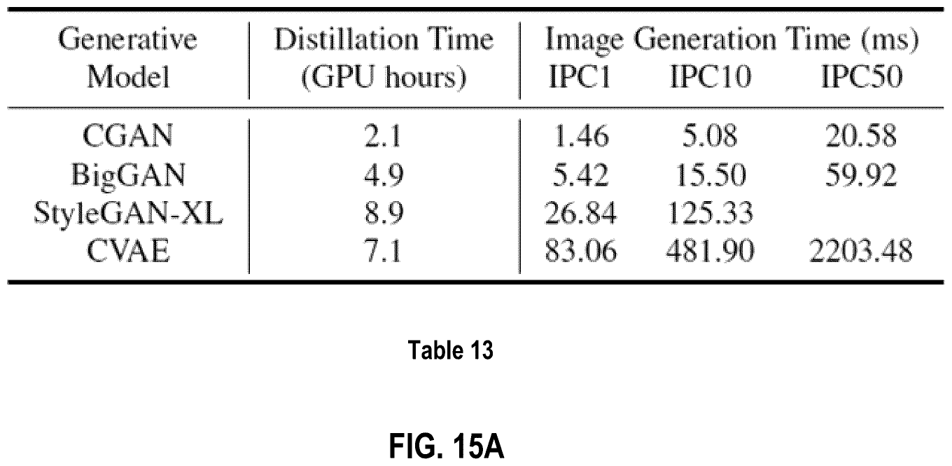

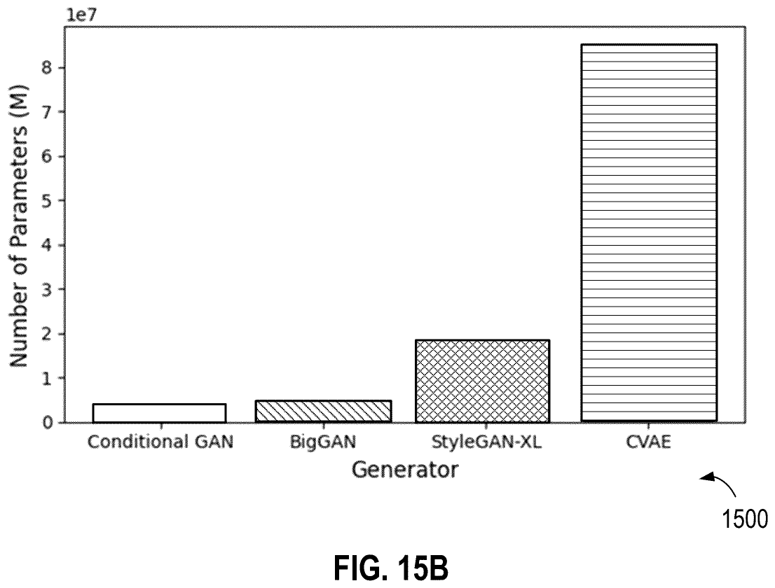

To enhance the computational efficiency of D2M when applied to less complex datasets, experiments using CIFAR-10 are conducted with various generative models in example embodiments of D2M system 100, including conditional GAN (CGAN), BigGAN, StyleGAN-XL, and CVAE. Conditional GAN stood out for its remarkably short distillation time and a minimal number of learnable parameters as shown in Table 13 in FIG. 15A and graph 1500 in FIG. 15B, respectively.

In some embodiments, when working with simple low-resolution datasets, D2M system 100 may include conditional GAN in generative model 220, 320, even if it means sacrificing a small degree of accuracy compared to other generative models. In other embodiments, BigGAN is implemented as part of generative model 220, 320 to achieve a balance between performance and computational costs, particularly when dealing with extensive and high-resolution datasets. In such complex scenarios, D2M system 100 outperforms all other dataset distillation methods in terms of computational efficiency and performance, even in small IPCs.

Unlike the pixel-wise dataset distillation algorithms, D2M system 100 can generate training images in real-time during the evaluation stage. To understand the computational effort involved in this step, an experiment using the CIFAR-10 dataset is conducted to measure how long it takes to generate images with various generative models. The results shown in FIG. 15B indicate that image generation typically takes just a few milliseconds GAN-based generative models are implemented as part of D2M system 100 under different IPC settings. Importantly, the time spent on image generation is a small fraction of the total evaluation time, usually less than 0.6% when using BigGAN.

In further experiments, the cross-architecture generalization capabilities of D2M-generated images for understanding classification tasks without overfitting to a specific architecture is explored. Various distillation systems and methods are run to generate synthetic dataset with a default network and their performances on unseen architectures are evaluated. Following the settings of Sajedi, A., Khaki, S., Amjadian, E., Liu, L. Z., Lawryshyn, Y. A., Plataniotis, K. N.: Datadam: Efficient dataset distillation with attention matching, in: Proceedings of the IEEE/CVF International Conference on Computer Vision. pp. 17097-17107 (2023) and Du, J., Jiang, Y., Tan, V. Y., Zhou, J. T., Li, H.: Minimizing the accumulated trajectory error to improve dataset distillation, in: Proceedings of the IEEE/CVF Conference on Computer Vision and Pattern Recognition. pp. 3749-3758 (2023), experiments using CIFAR-10 dataset with IPC 50 are conducted to test generalization with architectures like AlexNet, VGG-11, ResNet-50, DenseNet-121, and ViT, and findings are presented in Table 6 (680) in FIG. 6C.

Table 6 (680) in FIG. 6C shows that synthetic images from D2M system 100 not only generalize well across various models but also outperform the best competitor on average up to a margin of 3.9%. D2M system 100 provides the robustness of vision transformers and complex architectures like ResNet-50 and DenseNet-121 due to its powerful generative capability and distilled knowledge. This suggests D2M system 100 can identify crucial learning features beyond mere knowledge matching.

Referring back to FIGS. 2 and 3, synthetic images from synthetic dataset 290 can be produced by a refined generative model 220, 320, where

$$𝒮 = {\{ ( {s}_{j} , {y}_{j} ) \}}_{j = 1}^{\vert 𝒮 \vert} ,$$

which has comparable training power to the real dataset [symbol] 210.

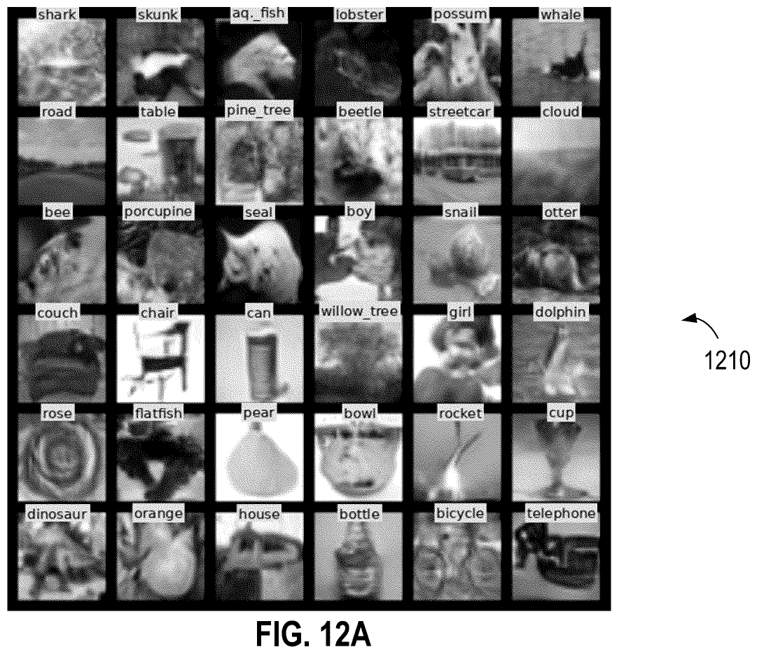

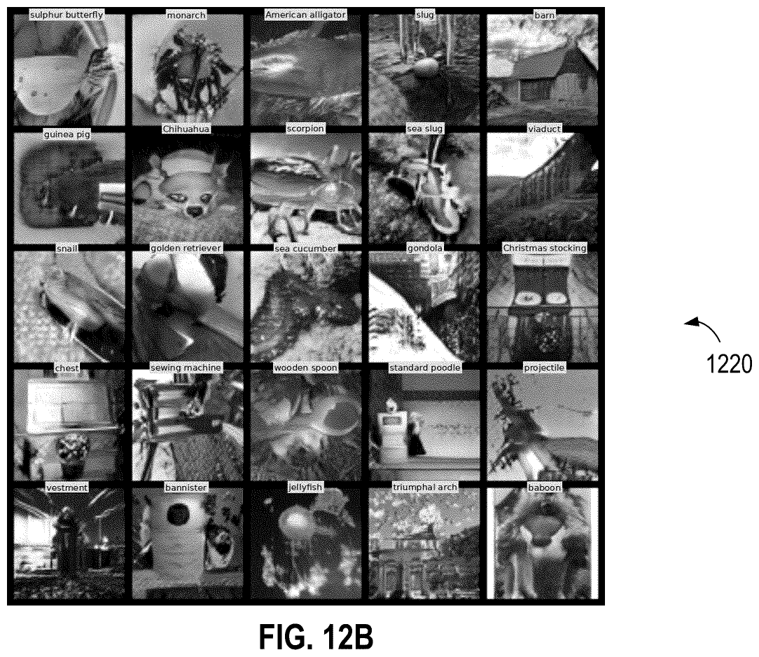

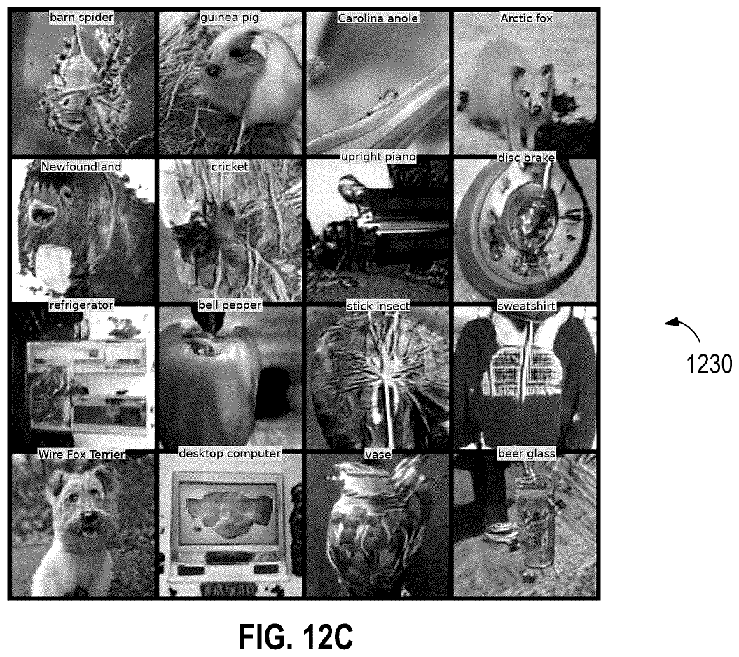

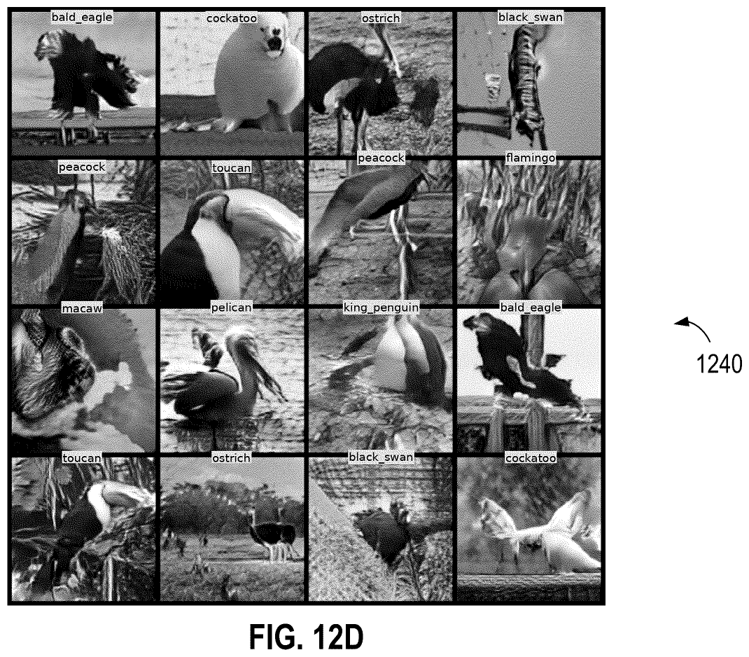

Example groups of synthetic images 1210, 1220, 1230, 1240 are shown FIGS. 12A, 12B, 12C and 12D, which are generated by the refined generative model 220, 320 in system 100 from 32×32 CIFAR-100, 64×64 Tiny ImageNet, 128×128 ImageNet-1K, and 128×128 ImageSquawk, respectively. The synthetic images are identifiable, although they may contain artificial patterns that improve their informativeness, like discriminative features of the animals. It can be seen that generative model 220, 320 prioritizes informativeness over realism.

As generated by the generative model 220, 320 in system 100, some synthetic images may be processed for application in Neural Architecture Search (NAS). The synthetic images can act as a proxy set to accelerate model evaluation in NAS. NAS operations are conducted in experiments on CIFAR-10 dataset with a search space of 720 ConvNets, varying in network depth, width, activation, normalization, and pooling layers. All architectures are trained, on Random, DSA, CAFE, DM, DAM, and D2M synthetic sets with IPC50 for 200 epochs, and on the full dataset for 100 epochs to establish a baseline. The architectures are then ranked based on validation performance and the corresponding accuracies of the best-selected model when trained on the test set.

Spearman's rank correlation also evaluates the reliability of synthetic images for architecture search, comparing testing performances between models trained on proxy and real training sets. As illustrated in Table 9 (1190) in FIG. 11B, D2M-generated images achieve the highest performance (88.8%) and a strong rank correlation (0.80) compared to priors.

In some example embodiments, a search domain containing 720 ConvNet configurations on the CIFAR-10 dataset is evaluated using a distilled dataset, with an IPC of 50 serving as a proxy dataset within the neural architecture search (NAS) paradigm. The evaluation process is based on a foundational ConvNet, forming a systematic grid that varies by depth DE {1, 2, 3, 4}, width WE {32, 64, 128, 256}, activation function A∈{Sigmoid, ReLu, LeakyReLu}, normalization technique N∈{None, BatchNorm, LayerNorm, InstanceNorm, GroupNorm}, and pooling operation PE {None, MaxPooling, AvgPooling}. These variants are then evaluated and hierarchically ordered based on their validation outcomes. In some embodiments, 10% of the CIFAR-10 training samples are randomly designated as validation subset, while the remainder formed the training set. DSA augmentation is applied across all proxy-set methods.

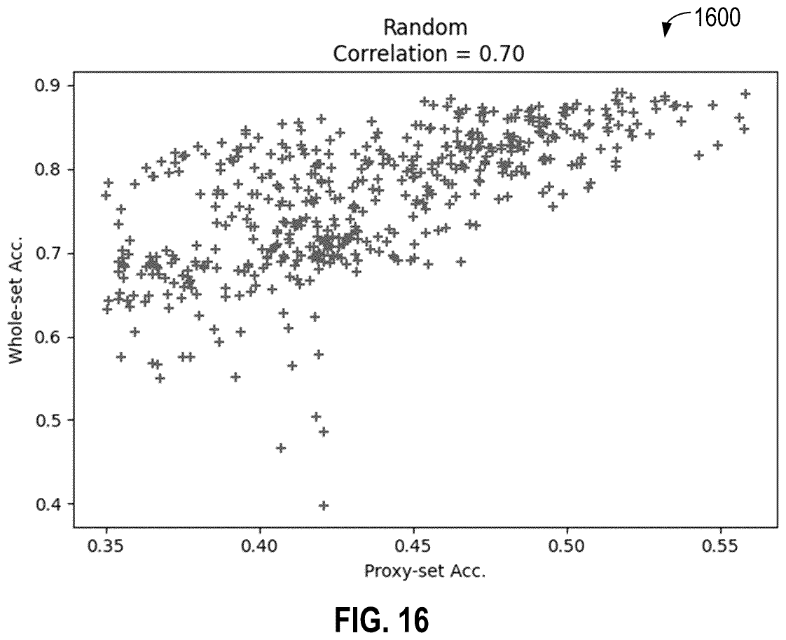

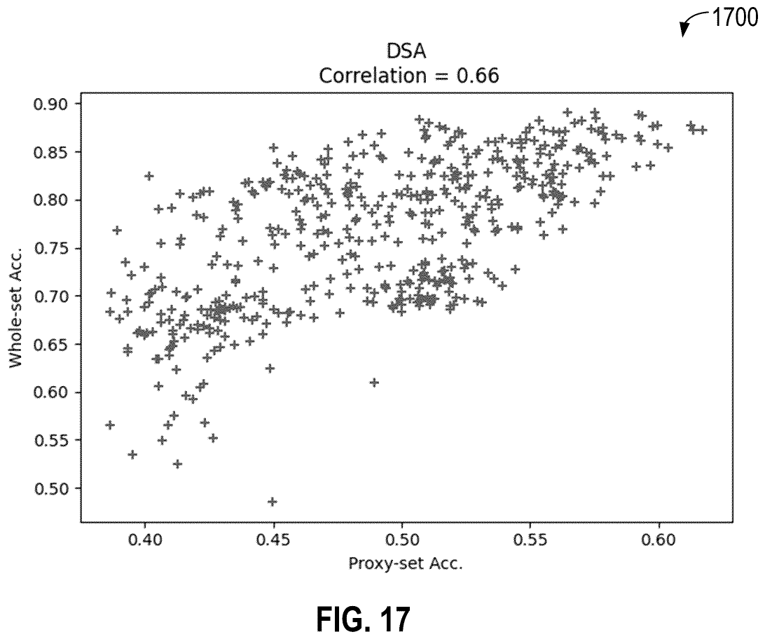

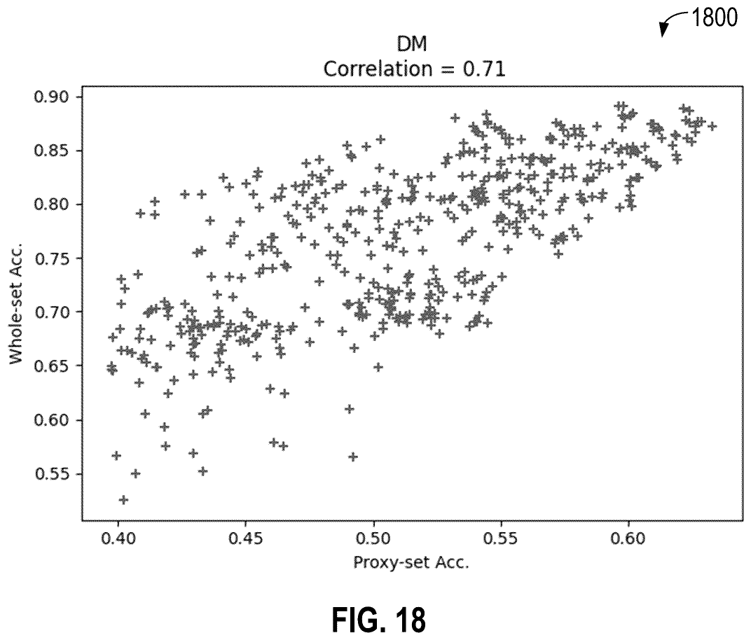

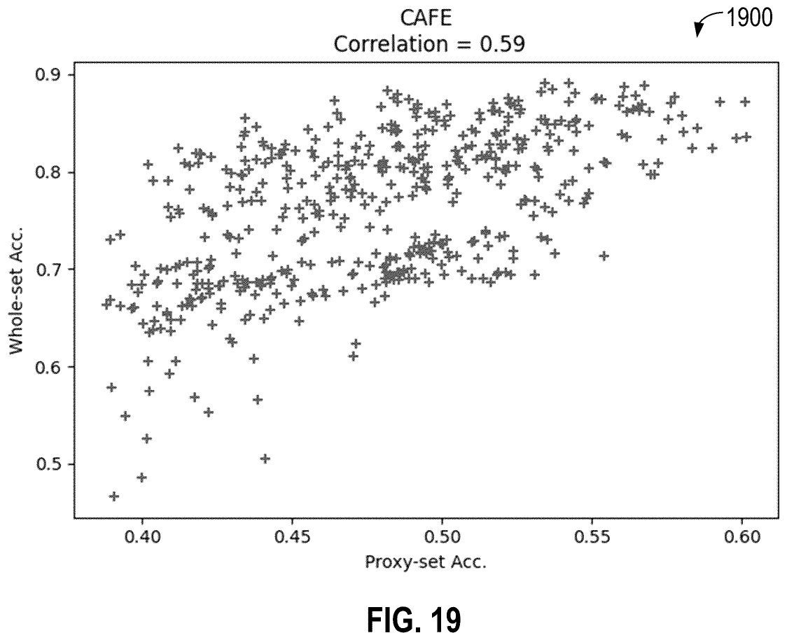

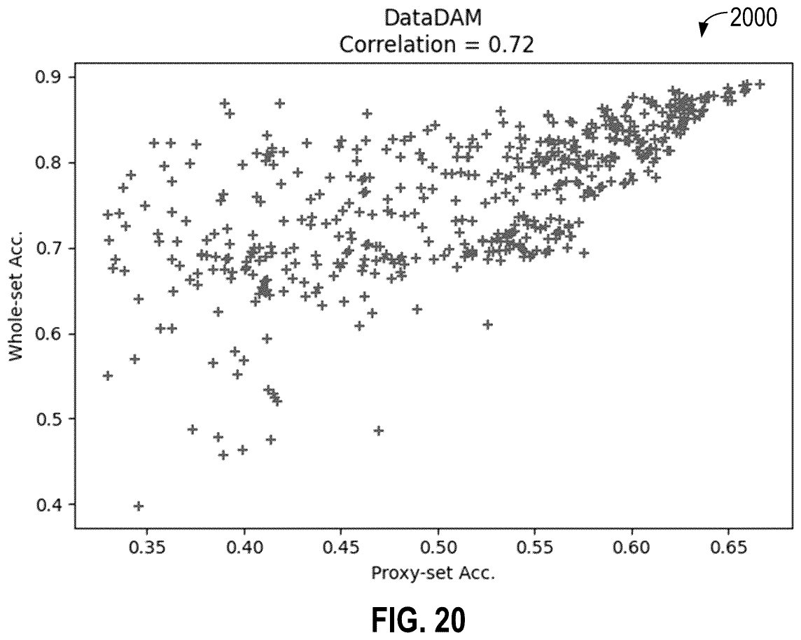

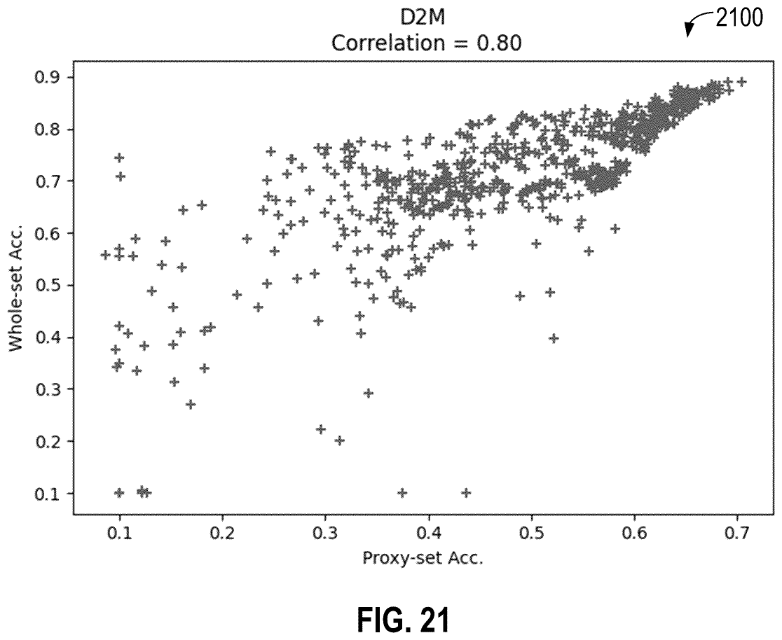

The rank correlation of performance between the proxy dataset, derived from Random, DSA, DM, CAFE, DataDAM, and D2M system, and the full training dataset are shown in charts 1600 (Random), 1700 (DSA), 1800 (DM), 1900 (CAFE), 2000 (DataDAM), 2100 (D2M) presented in FIGS. 16 to 21.

Spearman's rank correlation coefficient is used to analyze all 720 different architectural structures. Each point on the plot represents a unique architectural choice. The horizontal axis shows the test accuracy of models trained on the proxy dataset, while the vertical axis reflects the accuracy of models trained on the entire dataset.

The evaluation reveals that all methods are effective at generating reliable performance rankings for potential architectures. However, D2M system 100 stands out by having a larger cluster of points close to the straight line, indicating that it provides a more effective dataset for establishing dependable performance rankings of architectural choices.

D2M system 100 achieves a remarkable correlation coefficient of 0.80, surpassing the benchmarks set by previous studies. The charts 1600 (Random), 1700 (DSA), 1800 (DM), 1900 (CAFE), 2000 (DataDAM), 2100 (D2M) presented in FIGS. 16 to 21 validate that D2M system 100 can yield a proxy dataset that obtains a more reliable performance ranking of candidate architectures.

D2M system 100 can faithfully represent the distribution inherent in the original dataset. In some experiments, t-SNE is implemented for visualizing features extracted from both real and synthetically generated sets. These sets are produced by DC, DSA, DM, CAFE, DataDAM, and D2M, within the embedding space of the ResNet-18 architecture. The visualizations are conducted using the CIFAR-10 dataset with an IPC50, a consistent choice across all methodologies.

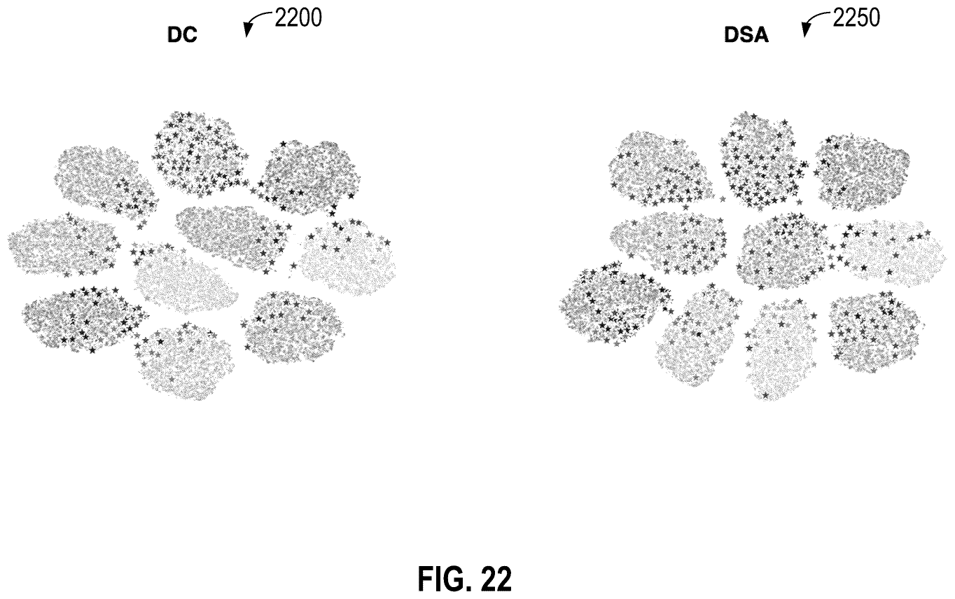

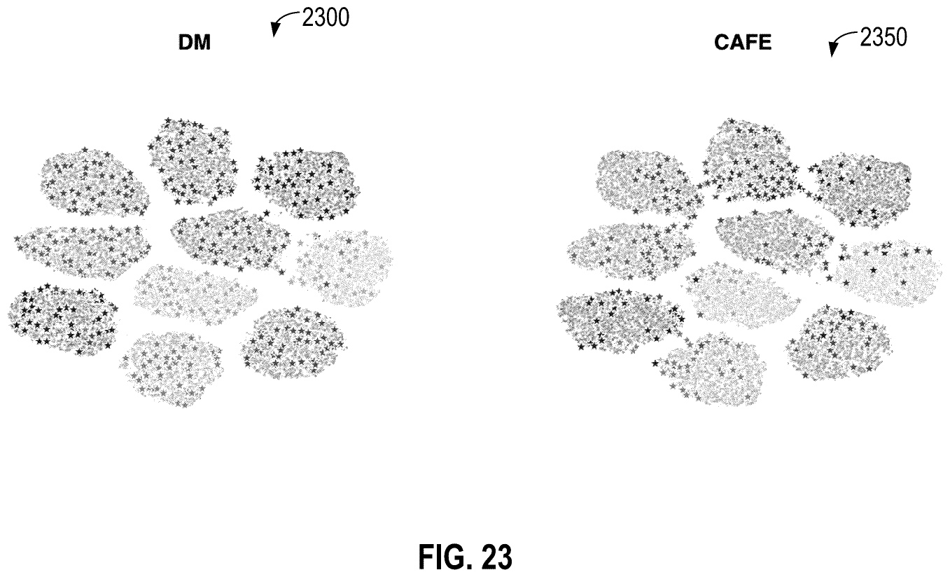

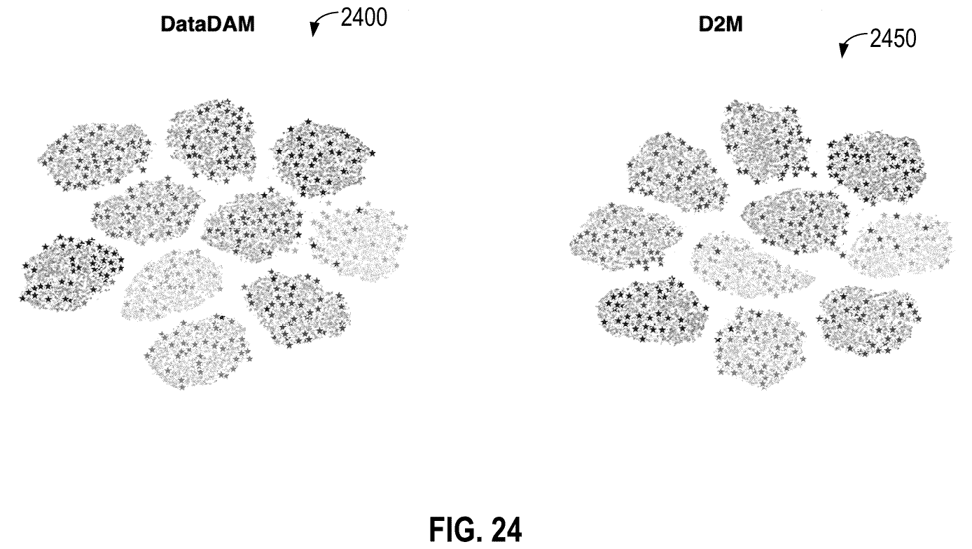

FIGS. 22 to 24 illustrate distribution graphs 2200 (DC), 2250 (DSA), 2300 (DM), 2350 (CAFE), 2400 (DataDAM), 2450 (D2M) of the synthetic images learned by various data distillation methods on the CIFAR-10 dataset with IPC 50. As depicted in these distribution graphs 2200, 2250, 2300, 2350, 2400, 2450, example embodiment of D2M system 100 used in the visualization experiments successfully preserves the dataset's distribution, manifesting as a well-balanced dispersion across the entire dataset. The stars represent the synthetic data dispersed amongst the original dataset. The classes are as follows: plane in green, car in yellow, bird in cobalt blue, cat in magenta, deer in cerulean, dog in mustard, frog in light purple, horse in grey, ship in teal, and truck in red.

Conversely, other methods such as DC, DSA, and CAFE exhibit noticeable biases towards certain cluster boundaries. In simpler terms, the t-SNE visualization validates that D2M system 100 maintains a significant degree of impartiality in accurately capturing the dataset's distribution consistently across all categories. Preservation of dataset distributions holds paramount importance, particularly in domains like ethical machine learning, as methodologies that fail to capture data distribution can inadvertently introduce bias and discrimination. D2M system 100 provides capability to faithfully represent the data distribution renders it more suitable than alternative approaches, particularly in applications such as facial detection for privacy considerations.

In some embodiments, images are generated with example embodiments of D2M system 100 trained on different temperatures T. A moderate temperature value enhances the influence of logit matching in KL-Divergence, resulting in better-distilled images suitable for classification and downstream tasks. As increase the temperature value is increased from 0.5 to 8, there is a noticeable improvement in the localization and alignment of objects within the image, particularly within the ‘car’ and ‘bus’ classes of images. Meanwhile, when examining the image at T=64, it appears that the quality and robustness of the image features have slightly diminished in comparison to the previous images. Nevertheless, it still retains a richer set of feature information compared to T=1.

In some embodiments, images are generated by example embodiments of D2M system 100 trained with different generative models. For example, conditional GAN, StyleGAN-XL, and CVAE and BigGAN are example generative models used in example embodiments of D2M system 100. Upon qualitative analysis, it can be observed that conditional GAN exhibits less distinct object localization compared to the other methods. This difference is particularly noticeable when examining the ‘cat’ and ‘bird’ classes. StyleGAN-XL stands out for producing high-quality images with rich colors and robust features across all categories. This is especially evident in the ‘car,’ ‘airplane,’ and ‘ship’ classes. Lastly, CVAE also generates clear images; however, when compared to Style-GAN-XL, it tends to lose some relevant background information, notably in the ‘airplane’ class.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code in instructions is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The foregoing discussion provides many example embodiments. Although each embodiment represents a single combination of inventive elements, other examples may include all possible combinations of the disclosed elements. Thus if one embodiment comprises elements A, B, and C, and a second embodiment comprises elements B and D, other remaining combinations of A, B, C, or D, may also be used.

The term “connected” or “coupled to” may include both direct coupling (in which two elements that are coupled to each other contact each other) and indirect coupling (in which at least one additional element is located between the two elements).

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements. The embodiments described herein are directed to electronic machines and methods implemented by electronic machines adapted for processing and transforming electromagnetic signals which represent various types of information.

The embodiments described herein pervasively and integrally relate to machines, and their uses; and the embodiments described herein have no meaning or practical applicability outside their use with computer hardware, machines, and various hardware components. Substituting the physical hardware particularly configured to implement various acts for non-physical hardware, using mental steps for example, may substantially affect the way the embodiments work.

The computer hardware components are clearly essential elements of the embodiments described herein, and they cannot be omitted or substituted for mental means without having a material effect on the operation and structure of the embodiments described herein. The computer hardware is essential to implement the various embodiments described herein and is not merely used to perform steps expeditiously and in an efficient manner.

The embodiments and examples described herein are illustrative and non-limiting. Practical implementation of the features may incorporate a combination of some or all of the aspects.

Although the embodiments have been described in detail, it should be understood that various changes, substitutions and alterations can be made herein without departing from the scope as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

1. A computer system for providing a machine learning model for image data distillation, the system comprising:
a processor; and
a non-transitory memory storing a set of instructions that when executed by the processor, causes the system to:
store or access a machine learning generative model comprising a generator network;
store or obtain an original image dataset comprising a plurality of original images;
store or obtain a random image dataset comprising a plurality of random noise images and corresponding labels; and
for each iteration from a plurality of iterations for refining the machine learning generative model:
generate a synthetic image using the generator network, based on a respective random image and a corresponding label for said respective random image from the random image dataset;
process the synthetic image in a forward pass using an embedding matching module to generate a synthetic embedding output for the generated synthetic image in a forward pass;
process a respective original image from the original image dataset using said embedding matching module to generate an original embedding output for the respective original image in a forward pass;
compute an embedding loss for said iteration based on the synthetic embedding output and the original embedding output;
determine a training loss for said iteration using the embedding loss; and
update the generator network of the machine learning generative model based on the training loss.

2. The system of claim 1, wherein when executed by the processor, the instructions cause the system to, for each said iteration from the plurality of iterations for refining the machine learning generative model:
compute a prediction matching loss for said iteration using a prediction matching module based on the synthetic embedding output and the original embedding output; and
determine the training loss for said iteration using the embedding loss and the prediction matching loss.

3. The system of claim 1, wherein: the synthetic embedding output comprises a feature map for the respective synthetic image; and the original embedding output comprises a feature map for the respective original image.

4. The system of claim 3, wherein the embedding loss is computed based on the feature map for the respective synthetic image and the feature map for the respective original image.

5. The system of claim 1, wherein the system comprises a randomly selected neural network implemented to align respective channel-wise attention maps between the original image dataset and a synthetic image dataset comprising the synthetic images generated by the generator network.

6. The system of claim 5, wherein the embedding matching module generates the embedding losses across different feature extraction layers using the neural network.

7. The system of claim 5, wherein the embedding matching module uses the most discriminative regions of the feature maps, based on the respective channel-wise attention maps, to align feature distributions between the original image dataset and the synthetic image dataset generated by the generator network.

8. The system of claim 2, wherein the synthetic embedding output comprises a predicted logit for the respective synthetic image and the original embedding output comprises a predicted logit for the respective original image.

9. The system of claim 8, wherein the prediction matching loss is computed based on the predicted logit for the respective synthetic image and the predicted logit for the respective original image.

10. The system of claim 9, wherein the system comprises a randomly selected neural network implemented to minimize differences in soft-label output predictions, by the generator network, between the output predictions based on the original image dataset and the output predictions based on the synthetic images generated by the generator network.

11. The system of claim 2, wherein the training loss comprises an augmented Lagrangian of the embedding loss and the prediction matching loss.

12. The system of claim 1, wherein during each said iteration, the set of instructions when executed by the processor, causes the system to: randomly select a neural network from a model data store comprising neural networks with different initializations.

13. The system of claim 1, wherein the set of instructions when executed by the processor, causes the system to:
after completing the plurality of iterations for refining the machine learning generative model:
obtain a first distillation ratio;
generate a first set of training images using the trained generator network based on the original image dataset and the first distillation ratio; and
store or process the first set of training images for downstream classification tasks.

14. The system of claim 13, wherein the set of instructions when executed by the processor, causes the system to:
after the generation of the first set of training images:
obtain a second distillation ratio different from the first distillation ratio;
generate a second set of training images using the trained generator network, without retraining the generator network, based on the original image dataset and the second distillation ratio; and
store or process the second set of training images for downstream classification tasks.

15. A computer-implemented method for providing a machine learning model for image data distillation, the method comprising:
storing or accessing a machine learning generative model comprising a generator network;
storing or obtaining an original image dataset comprising a plurality of original images;
storing or obtaining a random image dataset comprising a plurality of random noise images and corresponding labels;
for each iteration from a plurality of iterations for refining the machine learning generative model:
generating a synthetic image using the generator network, based on a respective random image and a corresponding label for said respective random image from the random image dataset;
processing the synthetic image using an embedding matching module to generate a synthetic embedding output for the generated synthetic image in a forward pass;
processing a respective original image from the original image dataset using said embedding matching module to generate an original embedding output for the respective original image in a forward pass;
computing an embedding loss for said iteration based on the synthetic embedding output and the original embedding output;
determining a training loss for said iteration using the embedding loss; and
updating the generator network of the machine learning generative model based on the training loss.

16. The method of claim 15, further comprising, during each said iteration:
computing a prediction matching loss for said iteration using a prediction matching module based on the synthetic embedding output and the original embedding output; and
determining the training loss for said iteration using the embedding loss and the prediction matching loss.

17. The method of claim 15, wherein the synthetic embedding output comprises a feature map for the respective synthetic image and the original embedding output comprises a feature map for the respective original image.

18. The method of claim 17, wherein the embedding loss is computed based on the feature map for the respective synthetic image and the feature map for the respective original image.

19. The method of claim 15, comprising randomly selecting and implementing a neural network to align respective channel-wise attention maps between the original image dataset and a synthetic image dataset comprising the synthetic images generated by the generator network.

20. The method of claim 19, wherein the embedding matching module generates the embedding losses across different feature extraction layers using the neural network.

21. The method of claim 19, wherein the embedding matching module uses the most discriminative regions of the feature maps, based on the respective channel-wise attention maps, to capture semantic information from the respective image datasets.

22. The method of claim 16, wherein the synthetic embedding output comprises a predicted logit for the respective synthetic image and the original embedding output comprises a predicted logit for the respective original image.

23. The method of claim 22, wherein the prediction matching loss is computed based on the predicted logit for the respective synthetic image and the predicted logit for the respective original image.

24. The method of claim 23, comprising randomly selecting and implementing a neural network to minimize differences in soft-label output predictions, by the generator network, between the output predictions based on the original image dataset and the output predictions based on the synthetic images generated by the generator network.

25. The method of claim 16, wherein the training loss comprises an augmented Lagrangian of the embedding loss and the prediction matching loss.

26. The method of claim 15, comprising, during each said iteration, randomly selecting a neural network from a model data store comprising neural networks with different initializations for the embedding matching module.

27. The method of claim 15, comprising:
after completing the plurality of iterations for refining the machine learning generative model:
obtaining a first distillation ratio;
generating a first set of training images using the trained generator network based on the original image dataset and the first distillation ratio; and
storing or processing the first set of training images for downstream classification tasks.

28. The method of claim 27, comprising:
after the generation of the first set of training images:
obtaining a second distillation ratio different from the first distillation ratio;
generating a second set of training images using the trained generator network, without retraining the generator network, based on the original image dataset and the second distillation ratio; and
storing or processing the second set of training images for downstream classification tasks.

29. A non-transitory computer readable medium storing machine interpretable instructions, which when executed by a processor, cause the processor to perform:
storing or accessing a machine learning generative model comprising a generator network;
storing or obtaining: an original image dataset comprising a plurality of original images, and a random image dataset comprising a plurality of random noise images and corresponding labels;
for each iteration from a plurality of iterations for refining the machine learning generative model:
generating a synthetic image using the generator network, based on a respective random image and a corresponding label for said respective random image from the random image dataset;
processing the synthetic image using an embedding matching module to generate a synthetic embedding output for the generated synthetic image in a forward pass;
processing a respective original image from the original image dataset using said embedding matching module to generate an original embedding output for the respective original image in a forward pass;
computing an embedding loss for said iteration based on the synthetic embedding output and the original embedding output;
determining a training loss for said iteration using the embedding loss; and
updating the generator network of the machine learning generative model based on the training loss.
